(19) United States
(12) Patent Application Publication
(10) Pub. No.: US 2014/0108078 A1
(43) Pub. Date: Apr. 17, 2014

(54) TASK SCHEDULING AND RESCHEDULING

(71) Applicant: Moose Loop Holdings, LLC, (US)

(72) Inventor: Ken R. Davis, Salt Lake City, UT (US)

(73) Assignee: Moose Loop Holdings, LLC, Salt Lake City, UT (US)

(21) Appl. No.: 13/712,925

(22) Filed: Dec. 12, 2012

Related U.S. Application Data
(60) Provisional application No. 61/569,599, filed on Dec. 12, 2011.

(51) Int. Cl. G06Q 10/06; G06Q 30/06

(52) U.S. Cl. CPC G06Q 10/063112; G06Q 30/0601
USPC 705/7.14

(57) ABSTRACT

Technology is described for scheduling and rescheduling a purchased task. The method may include receiving a defined time range and parameters for when the purchased task is to be performed. An anchor may be set on a scheduling calendar according to the defined time range and parameters received. Another operation may be estimating a task duration to perform the purchased task. One or more service providers able to perform the purchased task may be identified according to the anchor and for the task duration. A service provider may be selected based on schedule efficiency as a function of the anchor of the purchased task with respect to the scheduled anchors of scheduled tasks for each service provider. The purchased task may then be assigned to a selected service provider at an efficient schedule time.

### PRIORITY CLAIM

Priority is claimed to U.S. Provisional Patent Application Ser. No. 61/569,599, filed Dec. 12, 2011, which is hereby incorporated herein by reference in its entirety.

### BACKGROUND

Many goods can be purchased in a commoditized way. A consumer can have certain criteria when deciding to purchase a good and if the good meets the desired criteria, then the consumer generally does not care who provides the good.

Services have traditionally been less commoditized. Rather, services are typically purchased after comparing service providers to one another. For example, service providers can be compared through a bidding process, interviews, and/or online user feedback ratings. Even such service provider comparisons can be challenging for a consumer to interpret due to the non-uniformity in services supplied by various service providers. This has resulted in uncertainty to the consumer as to the comparative cost of services, reliability of services, and the quality of services provided by service providers.

### BRIEF DESCRIPTION OF THE DRAWINGS

FIG. 1A illustrates an example scheduling calendar according to various examples of the present disclosure.

FIG. 1B illustrates an example method for scheduling a purchased task.

FIG. 2 is a block diagram illustrating an example of a system for scheduling purchased tasks.

FIGS. 3A-3C illustrate an example of scheduling anchors.

FIG. 3D includes an example scheduling calendar with the example scheduling anchors from FIGS. 3A-3C.

FIG. 4 illustrates an example scheduling calendar showing availability of a service provider.

FIG. 5 illustrates an example of scheduling a purchased task into an existing scheduling calendar.

FIG. 6 illustrates an example scheduling calendar for a service provider.

FIG. 7 is a table that includes example characteristics that describe a plurality of service providers.

FIGS. 8A and 8B are tables that include example historical completion times for completing scheduled tasks.

FIG. 8C illustrates several best-fit curve examples for the various columns of data in FIG. 8A.

FIG. 9 illustrates an example of moving scheduled tasks within a scheduling calendar.

FIG. 10 illustrates an example of reordering scheduled tasks between service providers within a scheduling calendar.

FIG. 11 is a flowchart illustrating an example method for scheduling purchased tasks.

FIG. 12 is a flowchart illustrating an additional example method for scheduling purchased tasks.

FIG. 13 is a block diagram illustrating an example of a system for rescheduling purchased tasks.

FIG. 14 is a flowchart illustrating an example method for rescheduling purchased tasks.

FIG. 15 is a flowchart illustrating an example method for rescheduling purchased tasks.

FIG. 16 illustrates an example scheduling calendar according to various examples of the present disclosure.

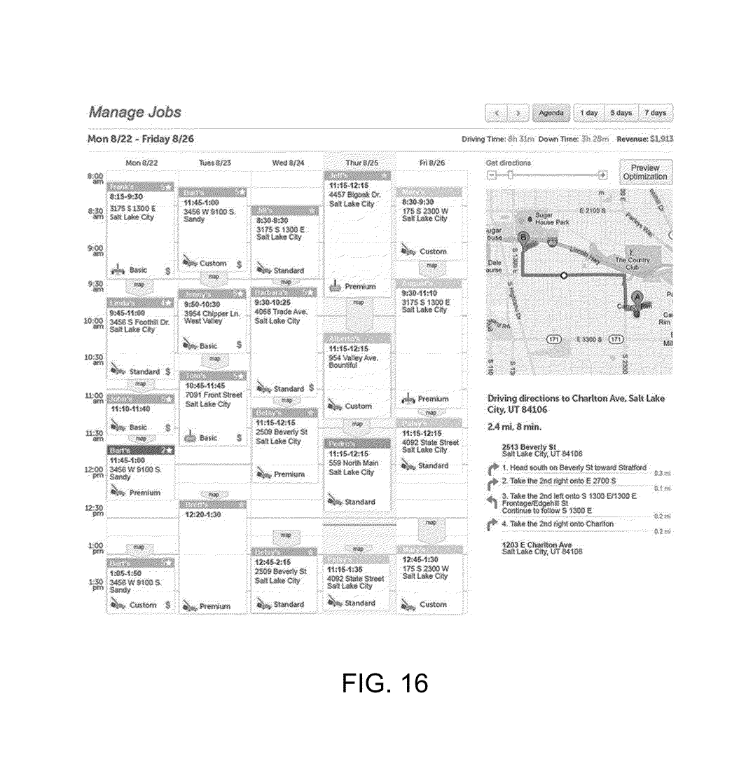

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure are to be considered within the scope of the description.

### Scheduling

A technology is described for efficiently scheduling tasks via a networked computing system. More accurate and efficient scheduling and rescheduling of services may allow the services to be priced and delivered in a more uniform fashion, improve the profitability of the service provider, decrease the cost to the customer, increase the quality and timeliness of the service provided, and/or allow the service provider to provide more services to more customers in the same amount of time. While access may be provided for any of a nearly limitless number of services provided by service providers, examples include various yard and home services, such as: lawn mowing, lawn fertilizing, basic home repairs, painting, cleaning, gardening, small appliance repair, etc. A service provider may be any service provider, contractor, service contractor, service group, or service supply entity that provides a service to a customer.

This technology may allow a user to select a service or task (e.g., lawn mowing) to be purchased electronically. A user interface on a client device may present choices to the customers that include task parameters and other details about the service. For example, the customer may specify a time range and parameters (e.g., Monday to Friday) to have a service provider perform the purchased task. A purchased task can be defined here as a new task that a customer purchases for performance by a service provider. The purchased task associated with the time period from the customer may be scheduled in a scheduling calendar. In particular, the purchased task may be scheduled to minimize a travel time of the service provider in performing the purchased task. Therefore, the purchased task may be scheduled to be performed by a service provider that is located in proximity or that has other customers located in proximity to the new customer and within the time period specified by the new customer.

Any number of time ranges and parameters that are specified may be contained in an anchor that is placed on a scheduling calendar. The anchor may be provided by a customer purchasing a task; a service provider who will perform the task; and/or an automated scheduling system based on system defaults, external inputs such as weather data, observations about the present location or timeliness of a services provider, and/or other time ranges and parameters. The use of an anchor can effectively provide increased flexibility to a service provider to perform a task, while still achieving the goals of the customer. By allowing flexibility, the service provider and task allocation technology can economize, thereby providing the opportunity to (a) make more profit over the same period of time, or (b) pass more savings along to the customers. Inasmuch, the customer can be motivated by the scheduling system to increase the size or relax the parameters of the anchor through price incentives.

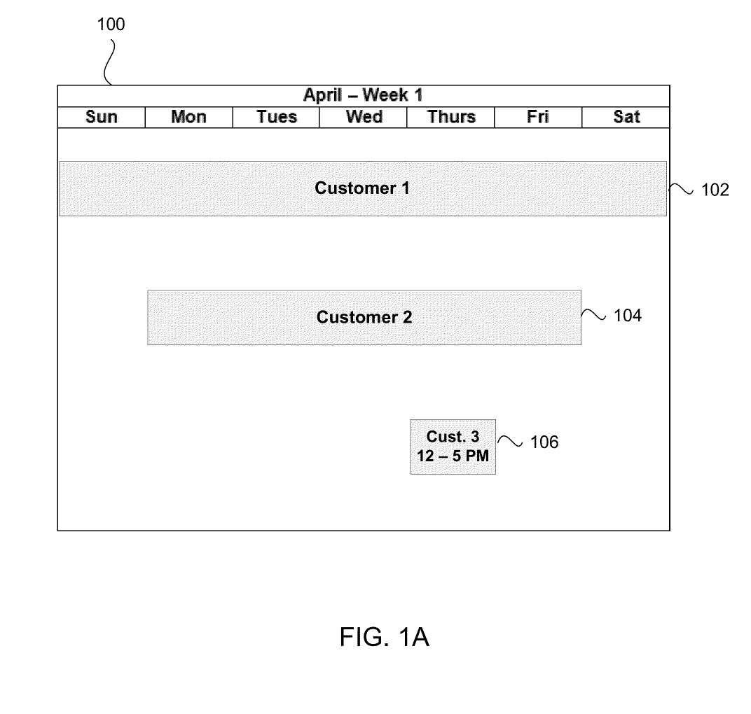

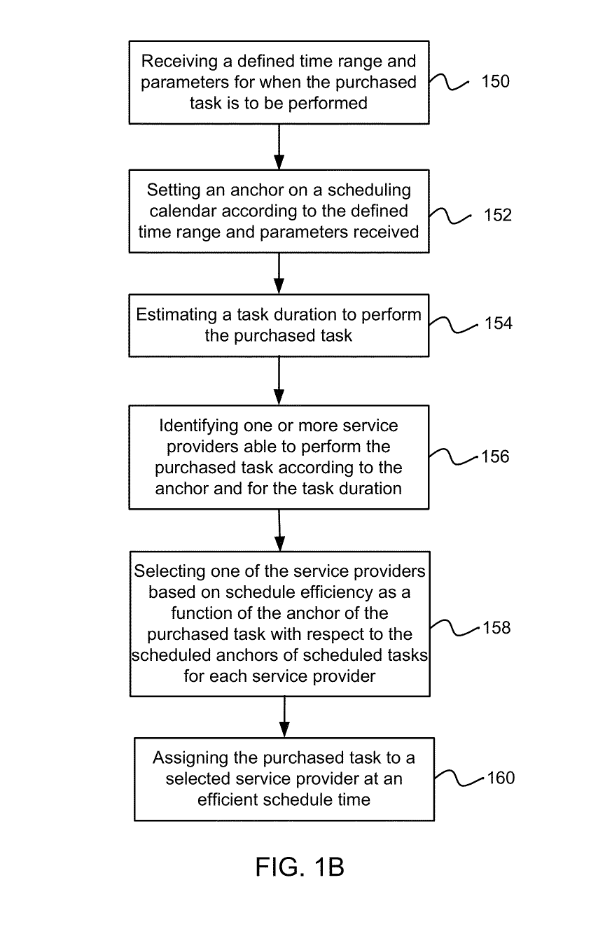

FIG. 1A illustrates an example scheduling calendar 100 according to various examples of the present technology. The scheduling calendar 100 may include one or more anchors indicating a desired time range for scheduling the performance of a purchased task. For example, customer 1 may purchase a lawn mowing task to be performed at some future time. However, customer 1 may be indifferent to the exact day and/or time that the purchased task is to be completed. Therefore, customer 1 may indicate that the lawn may be mowed at any time during a given week (e.g., Sunday to Saturday). In some examples, the task may be completed within working hours (e.g., 8 AM to 6 PM). Thus, an anchor 102 representing the desired time range for performing customer 1's purchased task may be placed on the scheduling calendar 100. In this example, a 7-day anchor may be placed in the scheduling calendar 100 because customer 1 specified that the purchased task be completed within a 7-day time frame.

In addition, the scheduling calendar 100 may include an anchor 104 for scheduling and performing customer 2's purchased task within Monday to Friday, and an anchor 106 to perform customer 3's purchased task on Thursday within 12 PM to 5 PM. As will be discussed in greater detail below, the purchased tasks may be performed by one or more service providers based on a variety of criteria (e.g., geographic location, schedule availability, skill level, etc.). In addition, the purchased tasks may be optimally scheduled to reduce costs and/or travel times associated with performing the tasks.

FIG. 1B illustrates an example method for scheduling a purchased task. The method may perform operations under the control of one or more computer systems with memory containing executable instructions to perform the scheduling processes for a plurality of customers and service providers.

A defined anchor may be received representing when the purchased task is to be performed, as in block 150. When a customer orders a task, the customer may provide any number of time ranges and parameters for the task to be performed. The parameters may be task-related parameters. The time range and parameters may include temporal constraints defining when the customer desires to have the purchased task performed. These constraints or any number of time ranges and parameters can be defined as an anchor. For complete clarity, the anchor is different than a scheduled time to perform a task. The anchor may indicate a larger range of time within which the task may be scheduled or performed. The anchor represents the flexibility for scheduling of the actual task, and a larger anchor provides greater flexibility than a smaller anchor.

The anchor can have any number of time ranges and parameters associated with the anchor, including simple time boundaries, waiting periods, multiple task periods, recurring tasks, boundary splitting, start and end times, and other parameters. Some examples of these time ranges and parameters will now be discussed in more detail. In one configuration, an anchor can be a simple temporal boundary in which the customer desires a single task to be performed (e.g. “I would like my house painted sometime within the next 14 days”). An anchor may further include a repeating temporal pattern in which the customer requests a recurring task to be performed (e.g. “I would like my lawn mowed every 7 days, but I don't care on which day it is mowed). In either case, the actual performance of the task is not likely to consume the entire temporal period specified by the anchor. A painting task might take 6 hours within the 14-day period of the anchor, and a lawn mowing task is likely to be an hour long, within the 7-day period of the anchor.

A waiting period can be included in the anchor before the temporal boundary or pattern (e.g. “I would like my lawn mowed every 7 days, I don't care on which day of the week it is mowed, but I would like it to begin in May;” or “I would like my Christmas lights hung on no earlier than November 1st, but definitely sometime within 30 days of November 1st”). So, the waiting period may include some amount of time before a task begins. Other time path critical pre-requisites may be included in the anchor where a certain type of service may need to be performed or materials are desired before the task may begin. For example, the roof of a shed may not be built until the materials have been delivered on site.

An anchor can have multiple valid periods (e.g. “I would like my house painted sometime before I have my parents in town or sometime after they leave.”) This may provide flexibility to a service provider in time periods where a customer would like the service performed but desires to outline one or more blackout periods where having the service performed is inconvenient to the customer. In a similar configuration, the anchor can specify how the task itself should be split up across temporal boundaries (e.g. “I need to build a new wall in my house, but the mud must dry for 2 days before it can be sanded and painted, and the second coat of paint must be applied the day after the first coat of paint; I am okay with the work being performed on any of the days over the next 30 days, but only if it is performed between the hours of 8 am and 7 pm”).

The anchor may include parameters to define a recurring task where each period the task recurs is defined (e.g. “I would like my lawn aerated each May, and then again each October”). In addition, a recurring task may specify that the recurring task may occur each week or month for the foreseeable future or with certain seasonal pauses (e.g. “I would like my lawn mowed beginning each spring and ending each fall, but not during the winter months”).

The anchor can apply to the start time of the task but not the end time of the task (e.g. “I want to break ground on a new project sometime before July 31^{st}”). In addition, the Anchor can apply to the end time of the task but not the start time of the task (e.g. “I want to make certain that my apartment for rent is completely ready for a new tenant before August 1st when they are scheduled to move in.”) The anchor can apply to the full task length from start time through the end time (e.g. “I would like a one hour massage sometime on Thursday between 1 pm and 5 pm.”) The anchor may also be identical to the task duration (e.g. “I need to have someone babysit my children between 10 am and 3 pm on Friday.”). Although this unique anchor type does not offer any schedule flexibility to the system and in this case, the flexibility may be extracted using other tasks whose anchors are larger than the anchors task durations, and which are free to move about the fixed task where the anchor is identical to the task duration.

An anchor can be assumed by the lack of customer input (e.g. some merchant processing rules may require that if a customer uses a credit card to pay for services, that the service be performed within 30 days, therefore, lacking another anchor specified by the customer the anchor might be “30 days.”) In an alternative example, if a customer orders lawn fertilization, there are particular times of the year, and particular temperature thresholds, where particular types of fertilizer should be or should not be applied (e.g. never fertilize your lawn when the temperature is greater than 70 degrees Fahrenheit). The system may automatically use those parameters for applying the anchor in the absence of specific customer input. Similarly, if a customer wants a lawn mowing task and does not provide a specific time range, then the default may be to schedule a lawn mowing job in the next 7 days, or a recurring task, at any time, every 7 days. An anchor on a scheduling calendar can also be set according to one or more defined time ranges and parameters received, as in block 152.

A task duration to perform the purchased task may be estimated, as in block 154. Each task can include a task duration and a task location. The task duration may be an estimate based on: a best-fit statistical analysis of other similar tasks, smoothed statistical measurements for the task duration of the same task having been previously performed, an estimated value provided by the customer or the services provider, or a default value provided by the system. A task duration may be an estimated time since the exact end time of many tasks may be variable. In some cases, a hard time frame for the task duration may not be set. The location may be a geographical address (e.g. Cartesian coordinates, latitude/longitude, postal address, floor or room number, etc.), or some other type of location (e.g. file drawer, book shelf slot, memory location, etc.).

A list of qualified services providers (e.g., candidate service providers), who can perform the purchased task (i.e., new task), can then be identified. Qualifications for selecting or filtering to the list of qualified service providers may include, but are not limited to: service territory, geographic eligibility, skill set, pricing, quality, licensing, insurance, and any other qualifications. More specifically, a task can fall within a service territory for a service provider. For example, the service provider can be willing and able to perform the task described at a specified location. For example, a lawn mowing company with workers exclusively in San Diego may be disqualified from mowing lawns in Boston. In a counter example, pool installers from Texas may be willing to install pools in Arizona. Service providers can be filtered out based on the service provider's skill set or the service provider's ability to perform the desired elements of the task. For example, if the customer has requested tree trimming as part of a general landscaping task, but a particular service provider only trims bushes and cares for gardens, then that service provider may not be qualified to perform that task.

Another qualification factor can be whether the service provider has pricing for their services that is at or below the pricing the customer is willing to pay. If a service provider charges rates that are higher than a customer is willing to pay for a purchased task, then the service provider may be removed from consideration for that task. In addition, the services provider may be checked to see if the service provider has a sufficiently high quality score and previous customer rankings that match the desired quality score and customer rankings desired by the customer who requested the purchased task. The services provider may also be checked for qualification in the areas of licensing, insurance, passing a criminal background check, passing a credit background check, and/or not being on the sex offenders' registry.

One or more service providers able to perform the purchased task may be identified according to the anchor and for the task duration, as in block 156. In other words, the list of qualified service providers can be further reduced to those service providers who have schedule availability which overlaps with the purchased task anchor (i.e., new task anchor), such that the entire purchased task duration or series of task durations can be performed within the availability of the service provider and such that the performance of the task can comply with the parameters of the purchased task anchor without violating the anchors of any of the service provider's other existing scheduled tasks.

One of the service providers may be selected based on schedule efficiency as a function of the anchor of the purchased task with respect to the scheduled anchors of scheduled tasks for each service provider, as in block 158. Scheduled tasks can be defined as previously existing tasks which are scheduled before a purchased task (i.e., a new task) enters the system. Each scheduled task associated with each qualified service provider who has schedule availability for the purchased task may be ranked in order of nearest proximity to the purchased task (based on travel cost, estimated drive time, estimated drive distance, and/or estimated distance in a shortest line on a map “as the-crow-flies”). Using a computing device, each one of these scheduled task anchors and durations can be examined to determine whether the purchased task may fit in proximity to (e.g., next to or substantially adjacent to) the scheduled task without violating any of the anchors or duration parameters for the purchased task or any of the scheduled tasks. Furthermore, this evaluation may possibly cause scheduled tasks to move around on the schedule for efficiency reasons and none of the movement of any of the scheduled tasks may violate any of the anchors or duration parameters for those scheduled tasks. Furthermore, the service provider's home base location (or other locations the service provider may input to the system) may be considered the default starting point and/or ending point for each contiguous time period of availability, and proximity to or from that home base location is also considered a candidate for fitting next to the purchased task.

In some instances, the number of permutations of possible arrangements of scheduled tasks to accommodate insertion of the purchased task may be large and computationally expensive (e.g. 40 tasks have 40!, or 8.16×10⁴⁷, possible arrangements), not even accounting for every possible start time, rest period, and other contributing permutation factors. Solving this scheduling problem by testing every possible combination is computationally infeasible. For this reason, a random-path genetic fitness function or other statistical methodology may be used to determine a schedule that approximates the best schedule. In other words, the genetic algorithm or other method can be used to optimize a scheduling calendar of the service provider. In addition, the genetic algorithm or other method may be used to select service providers.

The term “schedule efficiency” as used herein is defined as the cumulative amount of time or distance traveled to move from task to task in a service provider's schedule. The specific arrangement of tasks (while obeying the anchors for each of the scheduled tasks) which results in the smallest amount of time or distance traveled by service providers is considered the “most efficient schedule.” The term “most efficient schedule” is used to indicate a schedule that is substantially most efficient, due to the fact that the number of permutations of schedules may not allow a computer system to provably evaluate all possible permutations. However, a substantially most efficient schedule is obtainable using genetic algorithms and/or other useful statistical methodologies and may approach the “most efficient schedule.”

Schedule Efficiency may be computed according to an example set of rules as illustrated immediately below. However these rules may vary depending on the desired scheduling outcome.
1. Each service provider can provide a “home base” geographical location. Unless otherwise excepted, an assumption is made that the services provider start each day and end each day at the “home base” geographical location.
2. Each service provider can indicate one or more blocks of available time in which the system can freely schedule tasks. If desired, the service provider can override the “home base” location with an alternate “known location” for the beginning or end of any of these periods.
3. Each service provider can add one or more blocks of “schedule unavailability” (either one time or on a recurring basis) to indicate exceptions to the service provider's originally indicated availability. If desired, the service provider can override the “home base” location with an alternative “known location” for the beginning or end of any of these periods.
4. Each scheduled task can have an associated geographical location. Some complex tasks may have more than one geographical location (although for the sake of this description these complex tasks can be assumed to be treated as multiple tasks).
5. Each scheduled task can also have an estimated duration. The duration can be estimated based on: a best-fit transformation created from other similar tasks; from a statistical smoothing (e.g. computing the average) function based on actual times measured for the performance of an exact task in the past; a default value for the task; and/or a fixed interval for the task.
6. For any given arrangement of tasks, where the tasks are each adhering to the anchor's constraints, efficiency can be calculated as the sum of travel times from the home base (if at the start of a period of service provider availability), known location (if the service provider has specified an alternative to the home base), or task location (collectively denoted as Lᵢ) to the next task, home base (if at the end of a period of service provider availability) or known location (if the service provider has specified an alternative to the home base) (collectively denoted as Lᵢ₊₁) for all tasks in the services provider's schedule (n), which equals Schedule Efficiency k (SEₖ) for that particular arrangement of tasks; denoted as Σₙ₌₁ⁿ(Distance between Lᵢ and Lᵢ₊₁)=SEₖ. SEₖ may be computed for each value of k where the arrangement of tasks is different and the smallest value of SEₖ or Min(SEₖ) could be selected as the Minimum and therefore indicative of the most efficient schedule.
   In practical terms, computing Min(SEₖ) is unnecessary to achieve a substantially efficient schedule. Instead, Min(SEₖ) can be constrained to values of k where the arrangements contain tasks anchored within a finite period of time (e.g. one week or one month). Furthermore, one possible efficient way to compute Min(SEₖ) is to select v different k arrangements at random (where v is a statistically significant sample of k, say 100 different arrangements), compute (^{k}ᵥ): Min₁ (SE), then repeat the experiment computing (^{k}ᵥ): Min₂ (SE). If (^{k}ᵥ): Min₂ (SE)>=(^{k}ᵥ):Min₁ (SE) then stop and use (^{k}ᵥ): Min₁ (SE) as the substantially most efficient schedule, otherwise compute (^{k}ᵥ): Min₃ (SE). If (^{k}ᵥ): Min₃ (SE)>=(^{k}ᵥ): Min₂ (SE) then stop and use (^{k}ᵥ): Min₂ (SE) as the substantially most efficient schedule, otherwise continue until (^{k}ᵥ): Minₓ (SE)>=(^{k}ᵥ):Min₍ₓ₋₁₎ (SE) (for x=1 to m, where x is the xth test and m is the last test of x performed) and stop and use (^{k}ᵥ):Min₍ₓ₋₁₎ (SE) as the substantially most efficient schedule. In summary:

For x=1 to m, find the first:

$$\{ ( \begin{matrix}k \\ {v}_{x - 1}\end{matrix} ) \text{:} ( {Min}_{x - 1} [ {\sum }_{i = 1}^{n} ( Distance between {L}_{{( {v}_{x - 1} )}_{i}} and {L}_{{( {v}_{x - 1} )}_{( i + 1 )}} ) ] ) \} where$$

$$\{ ( \begin{matrix}k \\ {v}_{x}\end{matrix} ) \text{:} ( {Min}_{x1} [ {\sum }_{i = 1}^{n} ( Distance between {L}_{{( {v}_{x} )}_{i}} and {L}_{{( {v}_{x} )}_{( i + 1 )}} ) ] ) \} \geq \\ \{ ( \begin{matrix}k \\ {v}_{x - 1}\end{matrix} ) \text{:} ( {Min}_{x - 1} [ {\sum }_{i = 1}^{n} ( Distance between {L}_{{( {v}_{x - 1} )}_{i}} and {L}_{{( {v}_{x - 1} )}_{( i + 1 )}} ) ] ) \}$$

Where x is the xth test and m is the last text of x performed; and v is a pre-determined number of arrangements of the L's selected at random from k, where k is the set of all possible arrangements of the L's; for i=1 to n, where i is the ith task and n is the total number of tasks for the service provider.

The purchased task may then be assigned to a selected service provider at an efficient schedule time, as in block 160. In one configuration, to determine which of the services providers the purchased task may be assigned, a computer system performs an experiment where the purchased task is genetically optimized within each of the qualified service provider's schedules to determine which schedule is least impacted by the addition of the purchased task. The task may then assigned to the services provider whose schedule may be the least impacted.

A service provider bias to maintain tasks with the service provider that is already performing tasks for that customer may also exist. For a service provider who both mows lawns and trims trees, if the service provider is already mowing the lawn of a customer and that same customer orders a tree trimming task, the system may be strongly biased to try to select that service provider for the tree trimming task as an override to the normal selection method. Further, the service provider working with the customer may already be the most likely service provider to be selected, because of the proximity bias (there may be a distance of 0 between the lawn mowing task and the purchased tree trimming task). If an unexpected event occurs, such as unexpected weather or an accident, this method described earlier can be used to automatically and/or continuously reschedule a previously task. This selection bias may also apply after any task has been assigned to a service provider. For example, once a lawn mowing task is assigned to a services provider that task (and therefore customer) may not normally be assigned to a different services provider by the system, even if another services provider has a schedule that may be more accommodating or less impacted by that customer. The exceptions to this can include if the first service provider failed to perform the task properly, left the system completely, had a significant change in services territory, or manually requested to transfer or trade the customer.

A task price paid by the customer can be related to the flexibility of the anchor (less flexibility equals higher price). The selection of the time range for the anchor may be influenced to be as large as possible (e.g. non-restrictive) by using price incentives presented to the customer to accomplish this. A more restrictive time range or anchor may result in a bias for a higher overall price for the task, while a more flexible anchor may result in a bias for a lower price for the task. This is not to imply that in absolute terms the tasks with larger anchors are always priced lower than tasks with smaller anchors, as there are many other factors including schedule availability, quality, complexity, scope and size that might affect price.

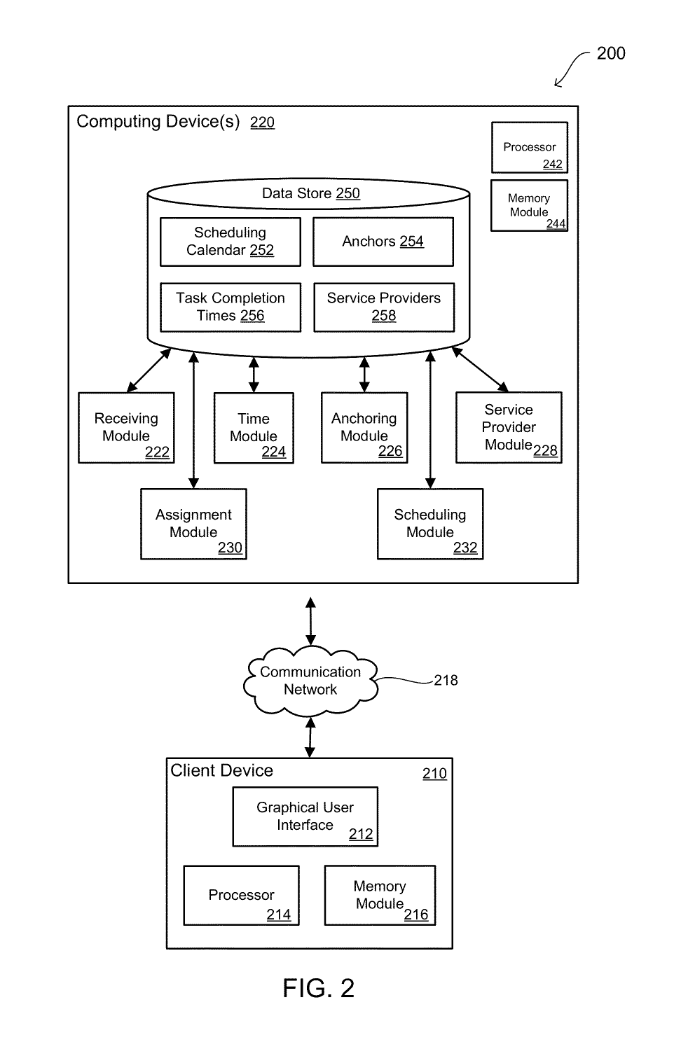

As illustrated in FIG. 2, a system 200 may be used for scheduling tasks. The system 200 may include a client device 210 through which a user can access information related to schedules, tasks and/or customers over a communications network 218. The communications network can be a local area network (LAN), wide area network (WAN), or the internet. A graphical user interface 212 can be provided to the user using the client device 210 to access the task, customer, and related information located on a separate computing device 220. A client device 210 with a graphical user interface 212 may be used by either a service provider or a customer.

Parameters for a task that the customer desires to be performed can be received by the graphical user interface 212 of the client device 210. For example, the customer may type, speak, write, or select task parameters that the client device 210 can capture. Payment for the task selected by the customer may also be supplied via the graphical user interface. In one example, payment via a credit card or debit transaction is collected before the task is assigned to a service provider for performance. The client device may include a processor 214 and a memory module 216. A client device 210 may be a device such as, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that may present the graphical user interface 212.

The parameters for a task collected by the client device 210 can be sent to a computing device 220. The computing device 220 may be provided with modules for scheduling purchased tasks. The computing device 220 may be a single server, a distributed server environment, a server farm, or any computing device or group of computing devices that may service requests from other computing devices or programs. In addition, the computing device may include one or more processors 242 and memory modules 244.

Various applications and/or other functionality may be executed in the computing device 220 according to various embodiments. Also, various data may be stored in a data store 250 that is accessible to the computing device 220. The term “data store” may refer to any device or combination of devices capable of storing, accessing, organizing, and/or retrieving data, which may include any combination and number of data servers, relational databases, object oriented databases, simple web storage systems, cloud storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media. The data stored in the data store 250, for example, is associated with the operation of the various applications and/or functional entities described below.

The data stored in the data store 250 may include a scheduling calendar(s) 252, task completion times 256, anchors 254, and/or service providers 258. The scheduling calendar 252 may include a plurality of scheduled tasks to be performed by one or more service providers. The scheduling calendar 252 may include the scheduled tasks for an upcoming time period (e.g., a week, a month, three months, a year). For example, the scheduling calendar 252 may include the tasks scheduled for October and November. The scheduling calendar 252 may be updated dynamically, as modifications to the scheduled tasks may continuously be updated on the scheduling calendar 252 in real-time. For example, a scheduled task may be moved to a following day and/or swapped with a different scheduled task. In addition, one or more of the scheduled tasks may be reordered with one or more different scheduled tasks. One or more of the scheduled tasks may be cancelled and may be rescheduled for a new day and time. Further, one or more of the scheduled tasks may be cancelled without rescheduling a new day and time to perform one or more of the tasks. In other words, scheduling and rescheduling of tasks can take place continuously for efficiency in compliance with anchors along with new observations, input from customers, input from service providers, and input from external data sources.

Once a scheduled task is completed, the scheduled task may be marked on the scheduling calendar 252 to indicate the completion. In addition, the scheduling calendar 252 may include information related to the plurality of scheduled tasks (e.g., the service provider assigned to perform the task, an estimated amount of time to complete the task, etc.). In some examples, the scheduling calendars 252 may include a separate calendar for each service provider, and each of the separate calendars may be globally accessible to the system 200.

The data stored in the data store 250 may include the anchors 254. As used herein, the term “anchor” generally refers to any number of time periods or parameters for describing when a customer desires to have a purchased task scheduled to be performed. In general, the terms “anchor” and “scheduling anchor” may be used interchangeably. In some examples, one or more anchors 254 may be included in the scheduling calendar 252. In addition, the desired time range of an anchor may vary from a small increment of time like 1 minute to 30 days or more. In general, the desired time range may reflect on the nature of the purchased task to be scheduled. For example, fixing a water heater may have a desired time range of 3 hours, whereas mowing a lawn may have a desired time range of 5 days. In some examples, the desired time range may be limited to a maximum of 7 days. In another example, certain tasks may have default time ranges, or anchors, in which they are to be performed. Swimming pool maintenance is a situation where, if the task is left unperformed for longer than some reasonable period (e.g. 15 days), damage could start to occur to the pool equipment or the water could become unhealthy. In general, the purchased task is to be completed within the anchor 254 indicated by the customer, or as indicated by default settings for the task. For example, a customer may purchase a lawn mowing task and indicate that the purchased task is to be completed within a 3-day time period (e.g., Wednesday to Friday). The purchased task may be scheduled for Wednesday, but unforeseen circumstances may delay completing the task until Friday. Since the purchased task was completed within the 3-day time period, the constraints of the anchor (i.e., completing the task within 3 days) were not violated. In other words, the purchased task (i.e., lawn mowing) was completed within the anchor included in the scheduling calendar 252. Alternatively, the customer may purchase a lawn mowing task and choose not to specify a desired anchor, in which case the anchor might default to a 7-day timer period for lawn mowing tasks (or other default as configured by an administrator). This default anchor assures that his task gets completed in a reasonable amount of time, even where the exact day or time is not important to the customer.

The data stored in the data store 250 may include task completion times 256. In general, the task completion times 256 may include historical information about the amount of time taken to complete a plurality of tasks (e.g., lawn mowing, snow plowing, garbage collection, pool maintenance). The task completion times 256 may be used to estimate an amount of time to perform a purchased task (i.e., a new task). For example, a customer may purchase a snow plowing task to be completed within one day. The customer may have a driveway that is 0.05 acres in size. In addition, the snowfall for the previous night may have been 5 inches. The task completion times 256 may include historical information of the amount of time taken for snow plowing either for the customer's specific task, having been completed before, or for other similar tasks. Furthermore, the task completion times 256 may include information on the area of the driveway plowed, as well as the amount of snow that had fallen. Thus, by analyzing the task completion times 256, it may be determined that driveways of a similar size (e.g., 0.05 acres) and a similar amount of snow (e.g., 5 inches) have historically taken approximately 30 minutes to plow. Therefore, the estimated time of 30 minutes may be used when scheduling the customer's purchased task in the scheduling calendar 252. A higher weighting may be assigned to historical data for a particular repeated task versus a similar task for estimating future times for performing the task. In the customer's case, even though the average task of a similar size and snow depth is 30 minutes, maybe the customer's driveway is strangely shaped and presents a difficult challenge for the snow plow operator and therefore takes slightly more time (e.g., 45 minutes on average) than similar tasks (e.g., 30 minutes).

The data stored in the data store 250 may include a list of service providers 258. The list of service providers 258 may be used to select a service provider to perform a task. The list of service providers 258 may be categorized by skill type (e.g., pest control, lawn mowing, snow plowing, gardening), skill level (e.g., beginner, experienced), quality (e.g., minimal, average, best), territory (e.g. the services provider only mows lawns in North Los Angeles), and/or schedule availability. For example, a customer may purchase a task for spraying his home to control the spread of ants. The customer may specify that the purchased task be scheduled on Wednesday. Thus, the service providers that are skilled in pest control and have availability on Wednesday may be identified to perform the customer's purchased task. In some examples, the list of service providers 258 may be categorized by the number of tasks that have been assigned to each service provider within a predetermined time frame (e.g., the past month). In addition, the list of service providers 258 may include a start location of each service provider (e.g., the address of the service provider) in order to determine a distance that the service provider may travel to perform a purchased task. In general, the term “location” may refer to a city, street, neighborhood, etc.

The components executed on the computing device 210 may include a receiving module 222, a time module 224, an anchoring module 226, a service provider module 228, an assignment module 230, a scheduling module 232, and other applications, services, processes, systems, engines, or functionality not discussed in detail herein. The receiving module 222 may be programmed to receive a desired time range from a customer. The desired time range may indicate when the customer desires to have the purchased task scheduled to be performed. For example, a customer (e.g., Sam) may purchase a task to have his windows washed. Sam may desire to be at home when his windows are washed, but is out of town on Thursday and Friday. Therefore, Sam may indicate that his windows may be washed during a time range of Sunday to Wednesday. In other words, the time range of Sunday to Wednesday may indicate the desired time range or anchor to have the purchased task scheduled to be performed. Alternatively, Sam may also indicate that his task should be performed in a time window, but NOT at a particular time. For example, maybe he desires the task to be performed between Wednesday and Sunday but NOT on Thursday and Friday. Thus, the anchor is more complex and effectively becomes either Wednesday, or Saturday/Sunday. In this manner, a set anchor for a task does not have to be a contiguous block of time, but could be multiple intervals of time, collectively; however, the multiple time intervals may still be one defined anchor.

The time module 224 may be programmed to determine an estimated amount of time to perform the purchased task for the customer. In some examples, the estimated amount of time to perform the purchased task may be determined based on the task completion times 256 to perform similar tasks. Continuing with the previous example, Sam may have a two-story home of approximately 3000 square feet. In order to determine an estimated amount of time to perform the purchased window cleaning task, the time module 224 may identify previously performed tasks relating to the purchased task to be performed for the customer. For example, the time module 224 may identify ten homes which have had windows washed in the past year. The ten homes may be two stories high and a similar size (i.e., 3000 square feet) as compared to Sam's home. The time module 224 may identify the task completion times 256 for the previously performed tasks. More specifically, the time module 224 may determine that the best-fit or average time to complete the previously performed tasks is approximately 3 hours. Accordingly, the time module 224 may determine an estimated amount of time for completing the purchased task for the customer based on the task completion times 256 of the previously completed tasks. Thus, the time module 224 may determine that washing Sam's windows may take approximately 3 hours.

The start and end times for a task may be collected via a mobile device that is being carried by the service provider. For example, historical data may be collected via a smart phone application installed on the service provider's phone, a tablet, a laptop, or another mobile device connected to a computer network. Data collected about a service provider's location while performing a task may be automatically collected via electronic location information gathered using GPS (Global Positioning Satellite) signals, wireless signal information, or similar electronic location detection. Thus, a device may automatically report when the service provider has entered an area where a service is to be provided. Alternatively, the user may enter information about the starting and ending of a task by personally entering the task related information into an application or selecting a user interface control (e.g., a button) in software to report that the service has started or stopped. When the user enters such information, then location information can be simultaneously recorded. Photos may also be taken before, after or during the performance of a task.

In general, the task completion times 256 of the previously performed tasks may not account for differences found in the purchased task performed for the customer. For example, Sam's purchased task may have specific characteristics (e.g., a series of 20-foot windows) that increase the amount of time for performing the purchased task. Therefore, the time module 224 may account for possible error when determining the estimated amount of time to complete the purchased task by marginally increasing the estimated amount of time. Thus, the time module 224 may estimate that washing Sam's windows may take approximately 4 hours, rather than 3 hours. In general, marginally over-estimating the time to complete the purchased task may decrease the likelihood of future scheduling conflicts if completion of purchased tasks becomes delayed. Alternatively, there may be a type of task (e.g. Doctor's appointments) where tasks are canceled at a high rate by customers. In this case, the time module 224 may marginally decrease the estimated amount of time for each task so that when some tasks are canceled the overall schedule is still populated and efficient (e.g. Ten 1-hour Doctor's appointments are scheduled for 48 minutes each during an eight hour day because 20% of all appointments, on average, are no-shows or cancellations, which will statistically mean only eight of the ten originally scheduled tasks will be performed).

The anchoring module 226 may be programmed to set an anchor on a scheduling calendar according to the desired time range received from the customer. The anchor may indicate a time range of when the purchased task is to be performed. Continuing with the previous example, Sam may indicate that the windows be washed within the time range of Saturday to Wednesday. In addition, Sam may indicate that the windows be washed within a time period of 7 AM to 6 PM. Therefore, an anchor may be included in the scheduling calendar 252 to indicate that Sam's purchased task is to be performed within Saturday to Wednesday within the time period of 7 AM to 6 PM each day. In some examples, one or more time periods might be part of a single anchor associated with performing the purchased task. For example, in addition to the time period from Saturday to Wednesday, Sam may create an anchor that indicates a second time period to perform the purchased task on the following Friday. In some examples, the second time period may be less desirable to the customer as compared to the time period indicating the most desired time range. Thus, performing the purchased task during the second time period may result in a discount and/or reward to the customer.

The service provider module 228 may be programmed to identify a service provider with a scheduled task in geographical proximity to the purchased task to be scheduled and the purchased task has an anchor that overlaps with either the schedule of the scheduled task or the larger anchor of the scheduled task. Continuing with the previous example, Sam may live in a neighborhood called Pleasant Hill. The scheduling calendar 252 may indicate that a service provider (e.g., Max) is scheduled to perform a scheduled task for Adam. The scheduled task for Adam may be scheduled on the same Wednesday included in the anchor indicating Sam's desired time range. In this case, the scheduled task for Adam may be within the anchor set for scheduling Sam's purchased task. In some examples, a task location associated with performing a purchased task may be in proximity to a task location associated with a scheduled task, and the anchors for the purchased and the scheduled tasks may accommodate both tasks being scheduled in series with each other. In addition, the service provider may be scheduled to perform the scheduled task for Adam in a neighborhood located approximately one mile from Sam's home. In one example, a distance of one mile may be represent the most efficient travel distance of any placement of the purchased task with any service provider, and may fall also conveniently fall within the stated services territory of that provider.

In an example, the service provider module 228 may identify the service provider, in part, based on a number of tasks previously assigned to the service provider within a predetermined time frame. The service provider module 228 may implement a “fairness principle,” where service providers that have been assigned fewer tasks as compared to a plurality of service providers may be more likely to be assigned a purchased task (i.e., a new task). For example, a service provider (e.g., Arnold) may have be assigned 25 tasks in the previous month, whereas a different service provider (e.g., Max) may have been assigned 8 tasks in the previous month. Therefore, the service provider module 228 may identify Max to perform a purchased task, provided all of the other criteria have been met.

The service provider module 228 may identify the service provider based on a service provider's schedule availability. For example, Arnold may have no availability on Wednesday because he may have a full schedule of tasks on Wednesday, whereas Max may be available on Wednesday to perform tasks. The service provider module 228 may identify the service provider based on a service provider's defined territory. In another example, Max may perform tasks in the Pleasant Hill neighborhood, as well as neighborhoods within a one-mile radius of Pleasant Hill. In addition, the service provider module 228 may identify the service provider based on a skill level possessed by the service provider to competently perform the purchased task. As a further example, Arnold may be skilled in pruning trees and mowing lawns, whereas Max may be skilled in washing windows. Therefore, tasks involving window washing are unlikely to be competently performed by Arnold, and thus the service provider module 228 may identify Max to perform a task related to window washing.

The assignment module 230 may be programmed to assign the purchased task to the service provider. In general, the assignment module 230 may assign the purchased task to the service provider identified by the service provider module 228. As previously discussed, the service provider may be identified based on the service provider's schedule availability, defined territory, skill level, etc. Returning to the previous example, the service provider module 228 may determine that a service provider (e.g., Max) possesses the skill level for washing Sam's windows. Max may also be located within a predetermined distance from Sam's home and be available to perform the purchased task on Wednesday (i.e., a day within the anchor set in the scheduling calendar based on Sam's desired time range). Therefore, the assignment module 230 may assign the purchased task of washing Sam's windows to Max.

The scheduling module 232 may be programmed to schedule the purchased task to be performed by the service provider in proximity to a scheduled task on the scheduling calendar. In addition, the scheduling module 232 may schedule the purchased task within the anchor indicating the desired time range of the customer. Returning to the previous example, the service provider (e.g., Max) may be scheduled to perform a scheduled task in a neighborhood that is geographically located within a predetermined distance (e.g., one mile) from performing Sam's purchased task. Therefore, the scheduling module 232 may schedule Sam's purchased task in proximity to the scheduled task (e.g., before or after the scheduled task). In some examples, the scheduling module 232 may schedule the purchased task according to an estimated amount of time to perform the purchased task. Therefore, if the estimated amount of time to perform Sam's purchased task is 4 hours, the scheduling module 232 may accordingly schedule the purchased task to be completed from 1 PM to 5 PM. As a result, Sam's purchased task is completed within the anchor specifying that the purchased task be completed within Saturday to Wednesday. Also, by completing the purchased task by 5 PM, the scheduling module 232 complies with the anchor constraining the purchased task to be completed no later than 7 PM.

A task may be performed over multiple days or time periods, while still being contained within the overall defined anchor. For example, a task may be 16 hours long, but at task configuration time the task parameters may be defined as part of the anchor, either by the customer or the system, that the task can be “divided over multiple days into one or more periods” (maybe with parameter constraints such as: “cannot be divided into more than two periods”). However, the anchor may also specify that the task may be performed anytime from Sunday to Saturday. Another constraint might be that the time slots, although they can be split, must still be contiguous. Therefore, an appropriate scheduling would be to schedule half of the work for Wednesday and half for Thursday, each within the 6 am to 7 pm time constraints.

The scheduling module 232 may be configured to schedule the purchased task to be performed as a recurring task by setting a plurality of anchors on the scheduling calendar 252. The plurality of anchors may correspond to a recurring desired time range to perform the recurring task. For example, Sally may desire to have her indoor roses watered on each Monday for the entire year. In other words, the task of watering the roses may be considered a recurring task. Therefore, a plurality of one-day anchors may be set on the scheduling calendar 252 to indicate that Sally's roses are to be watered on Mondays for the entire year. In addition, recurring tasks may be scheduled based on customer expectations. For example, a customer may purchase a recurring lawn mowing task to be performed once a week between Mondays and Fridays. Although scheduling the lawn to be mowed on Friday and a Monday following a Friday lawn mow task may be within the constraints of the anchors, it may be undesirable to mow the lawn twice within a three-day period. Therefore, in an additional definable constraint of the anchor is to specify that the recurring tasks may be scheduled with a minimum predetermined gap between performing the tasks either by default or as specified by the customer (e.g., 5 days).

The scheduling module 232 may move the purchased task to be performed by the service provider within the anchor in order to optimize travel time or distance (i.e. efficiency) associated with performing the purchased task. For example, a service provider may be scheduled to mow the lawn of a customer in Brentwood on Thursday. However, the service provider may also be going to Brentwood on Friday to perform a different scheduled task that may not be moved. Therefore, the scheduling module 232 may move the scheduled task automatically from Thursday to Friday (as long as the move complies with the anchor constraints), as this may reduce travel time because the service provider is already in Brentwood.

The scheduling module 232 may be configured to reorder the purchased task desired by the customer and the scheduled task within the anchor in order to optimize travel times associated with performing the scheduled task and the purchased task for the customer. In addition, the scheduling module 232 may reorder one or more scheduled tasks to be performed by the same service provider, as long as the reordering complies with the anchor constraints of the scheduled tasks. For example, a service provider may be scheduled to perform three scheduled tasks at Park Place, Bellmont Avenue, and Park Place, respectively, on Monday. Therefore, the system may reorder the scheduled task on Bellmont Avenue with the scheduled task on Park Place in order to perform two adjacent scheduled tasks near the same location, thereby optimizing the travel time or travel distance (i.e. efficiency) associated with performing the scheduled tasks.

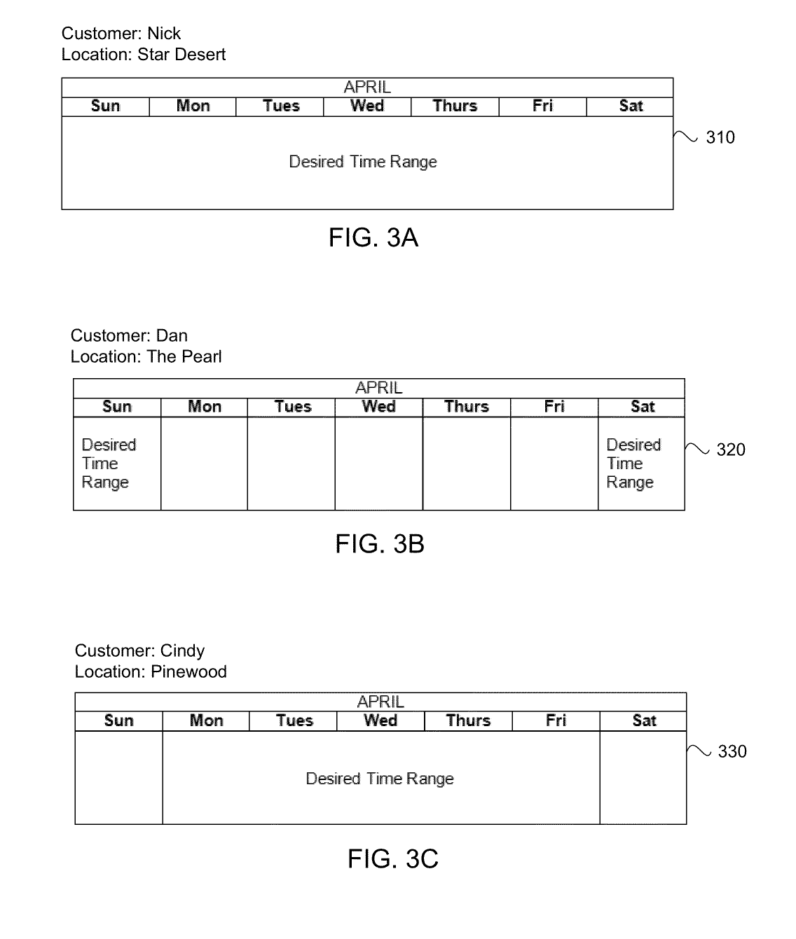

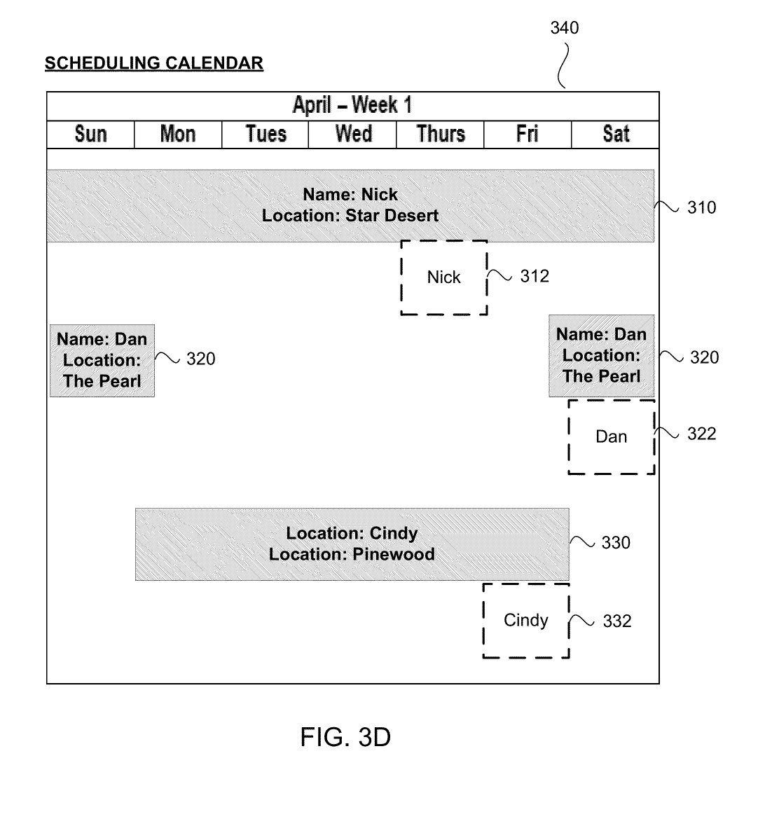

FIGS. 3A-3C illustrate example scheduling anchors 310, 320, and 330 that may be included in an example scheduling calendar 340 (shown in FIG. 3D). For example, a scheduling anchor 310, in FIG. 3A, may represent the desired time range (e.g., one week) to perform a purchased task for a customer (e.g., Nick). In addition, the scheduling anchor 310 may include or be associated with a location (e.g., Star Desert) of the customer. As an additional example, a scheduling anchor 320, in FIG. 3B, may represent the desired time range (e.g., Saturday and Sunday) to perform a purchased task for Dan. In addition, Dan may be located at The Pearl. Additionally, the scheduling anchor 330, in FIG. 3C, may represent the desired time range (e.g., Monday to Friday) to perform a purchased task for Cindy. In addition, Cindy may be located at Pinewood. The scheduling anchors 310, 320, and 330 for Nick, Dan, and Cindy, respectively, may be included in the scheduling calendar 340 as in FIG. 3D. As previously discussed, the scheduling anchors may represent the desired time ranges indicating when the customers desire to have the purchased tasks scheduled. Furthermore, the location of each customer (e.g., Pinewood) may be used to identify one or more service providers to perform the purchased tasks for the customers (e.g., Nick, Dan, Cindy). Subsequently, the purchased tasks for the customers may be scheduled to be performed at a certain day and time. For example, the scheduling calendar 340 may indicate that Nick's purchased task is scheduled to be performed on Thursday 312, Cindy's purchased task is scheduled to be performed on Friday 332, and Dan's purchased task is scheduled to be performed on Saturday 322).

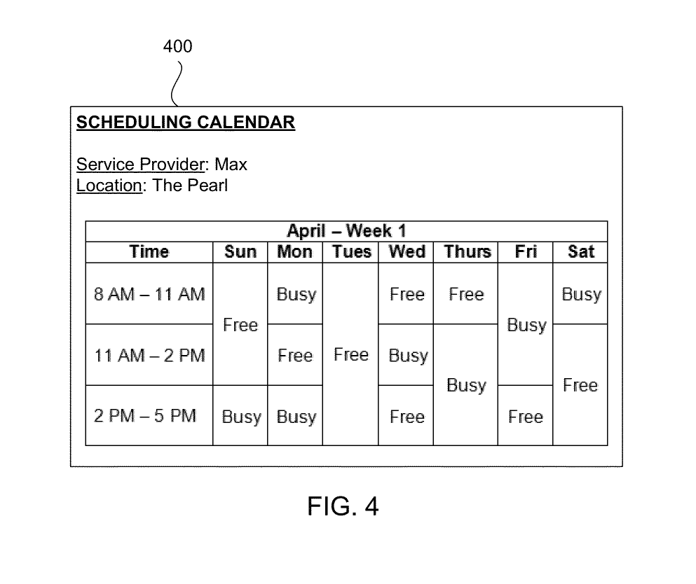

FIG. 4 illustrates an example scheduling calendar 400 of a service provider. As previously discussed, the service provider module 228 may identify a service provider based on the service provider's schedule availability. The scheduling calendar 400 of a service provider (e.g., Max) may include a location associated with the service provider (e.g., The Pearl), and a listing of free/busy time slots. In an example, the location associated with the service provider may be a start location of the service provider (e.g., the service provider's office). In some cases, the time slots marked as “busy” may indicate that the service provider is already scheduled to perform a scheduled task. In addition, busy time slots may indicate that the service provider is unwilling and/or unable to perform purchased tasks during that time slot. In contrast, a “free” time slot may indicate that the service provider is able to perform a purchased task during that time slot. The scheduling calendar 400 indicates that the service provider has free time slots on Saturday and Sunday, and that the service provider is located in The Pearl. Therefore, the service provider may be scheduled to perform Dan's purchased task from FIG. 3D. In other words, the service provider may perform Dan's purchased task because both parties are both located in the same area, and the service provider is free during the scheduling anchor 320 based on Dan's desired time range (i.e., Saturday and Sunday). In addition, based on the service provider's availability during the week, the service provider may perform Nick's purchased task from FIG. 3D.

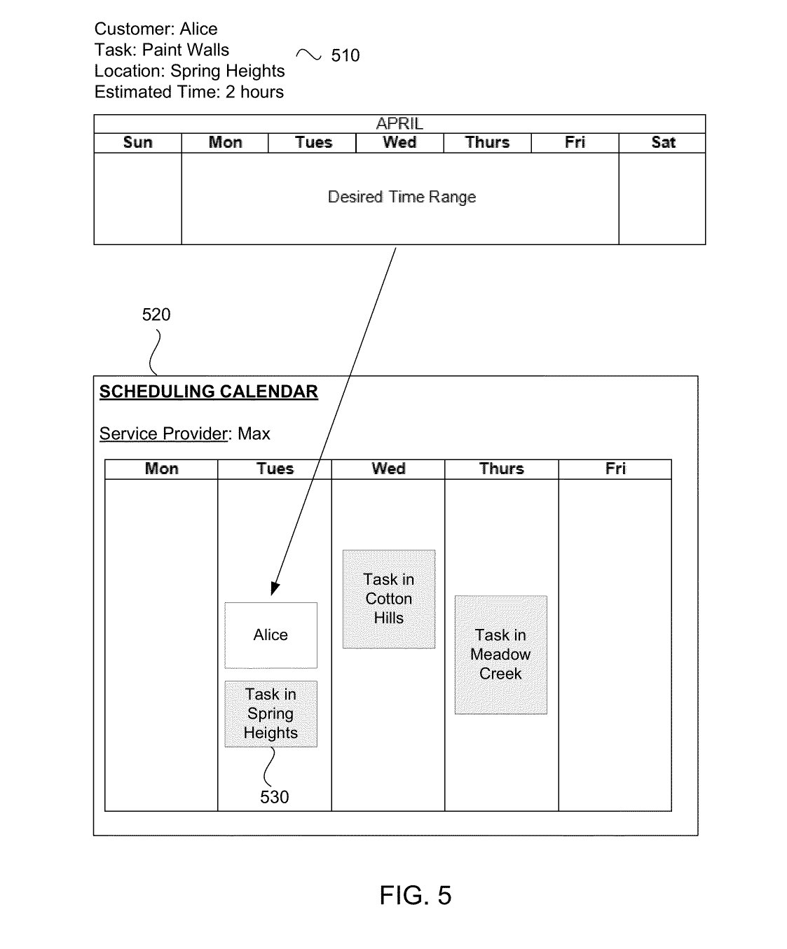

FIG. 5 illustrates an example of scheduling a purchased task into a scheduling calendar 520. For example, a customer (e.g., Alice) may purchase a task for painting a wall in her home. In addition, information 510 may be included that is associated with the purchase, such as the desired time range to perform the purchased task (e.g., Monday to Friday), the estimated amount of time to complete the task (e.g., 2 hours), and/or the location of the purchased task (e.g., Spring Heights). Thus, a service provider may be identified according to the information 510 describing the purchased task, based on geographic location, skill level, schedule availability, etc. Thereafter, the purchased task may be scheduled to be performed by the service provider in a scheduling calendar.

In this example, the purchased task may be already assigned to a service provider (e.g., Max). Thereafter, the purchased task may be optimally scheduled within the assigned service provider's scheduling calendar 520. For example, Max's scheduling calendar 520 may indicate that he is currently scheduled to perform scheduled tasks in Spring Heights on Tuesday 530, Cotton Hills on Wednesday, and Meadow Creek on Thursday. As Max's scheduled task on Tuesday is also in Spring Heights, Alice's purchased task may be scheduled to be performed prior to the scheduled task in Spring Heights. By scheduling Alice's purchased task prior to the scheduled task, the travel time associated with traveling between the two tasks may be reduced. In contrast, scheduling Alice's purchased task on either Wednesday or Thursday may result in a larger travel time, as it may be reasonably calculated that traveling from the areas of Cotton Hills or Meadow Creek to Spring Heights is a greater distance compared to travelling within the area of Spring Heights.

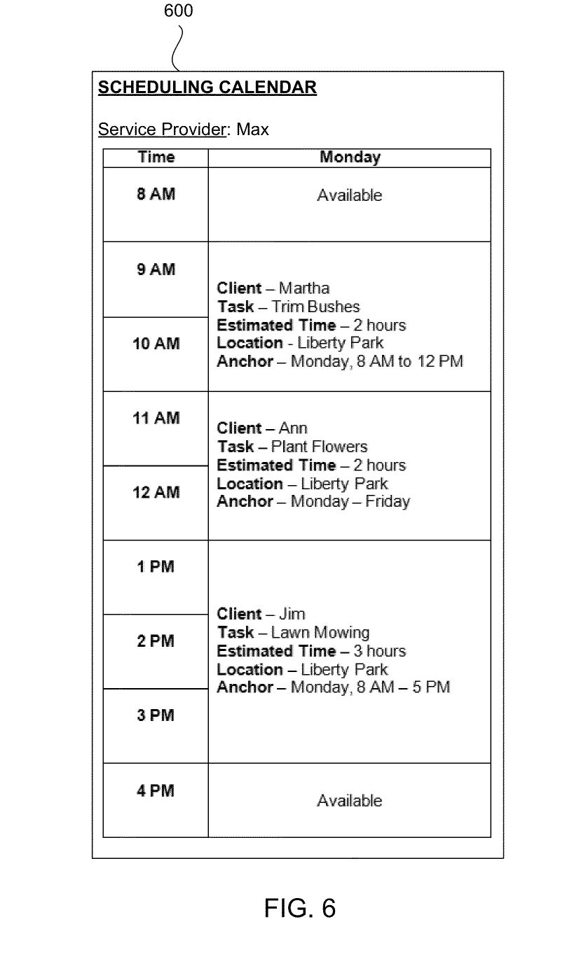

FIG. 6 illustrates an example scheduling calendar 600 of a service provider. The scheduling calendar 600 may include the scheduled tasks to be performed by a service provider on a particular day (e.g., Monday). The scheduled tasks may include trimming bushes for Martha from 9 AM to 11 AM, planting flowers for Ann from 11 AM to 1 PM, and lawn mowing for Jim from 1 PM to 4 PM. The scheduled tasks may be scheduled based on the estimated amount of time to complete the task. For example, Martha's task may be scheduled from 9 AM to 11 AM based on a 2-hour estimated completion time. The estimated amount of time to complete the task may include a travel time associated with travelling to the next scheduled task. In addition, the scheduled tasks in the scheduling calendar 600 may be scheduled within the anchors indicating the desired time ranges to perform the scheduled tasks. For example, Martha's purchased task may be scheduled to be performed within the anchor of Monday, 8 AM to 12 PM. Furthermore, the scheduling calendar 600 may be optimized by scheduling the scheduled tasks within the same location (e.g., Liberty Park), thereby reducing the travelling time associated with travelling between the scheduled tasks.

The start and end times that are a parameter associated with an anchor may be set by a customer or by default as constraining the start time of a task but not the end time of the task, or constraining the end time of the task while not constraining the start time. Setting a constraint on either the start time or end time, but not both, also means that a portion of the task may be allowed to move outside the anchored time. The task may be able to extend before or after the anchor as long as either the begin time or end time are within the anchor. This is an additional parameter that can be provided either by the customer, the service provider, and/or as a default parameter by the system, depending on whether the entire task is to fit within the anchor, just the start time is to fit within the anchor, or just the completion time is to fit within the anchor.

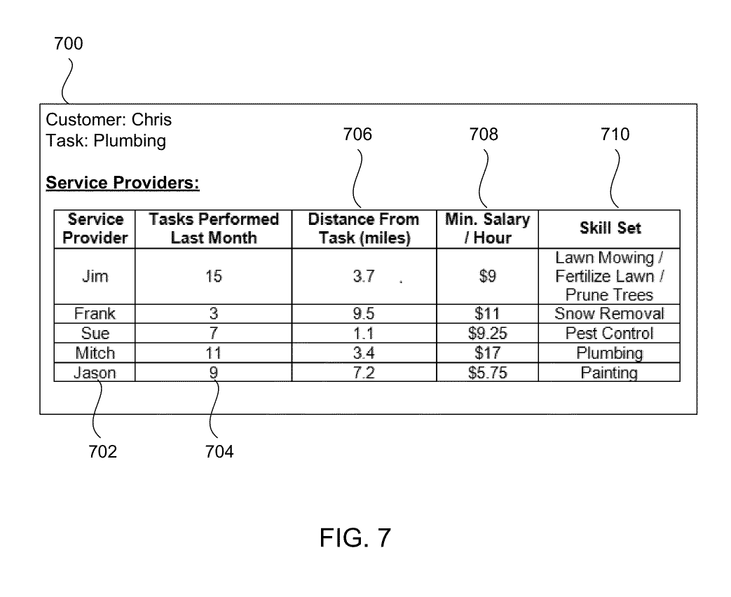

FIG. 7 is a table 700 that includes example characteristics that describe a plurality of service providers 702. Generally, the table 700 may be used to identify a service provider to perform a purchased task. For example, a customer (e.g., Chris) may purchase a plumbing task to be performed the following day. The table 700 may include, but is not limited to, for the plurality of service providers 702, the number of tasks performed in the previous month 704, a distance to the purchased task 706, parameters for minimum acceptable pricing for a task 708, and/or a skill set 710. As previously discussed, a “fairness principle” may dictate that purchased tasks (i.e., new tasks) be assigned to service providers that have been assigned fewer tasks within a predetermined time period (e.g., the previous month) as compared to the plurality of service providers. Further, purchased tasks may be assigned to a service provider that is located the smallest distance from performing the purchased task. In some examples, service providers may establish parameters for minimum pricing for tasks, and thus may decline tasks that are below the minimum desired price. In addition, a skill set of a service provider may be related to the purchased task desired by the customer. For example, a service provider (e.g., Mitch) may be skilled in plumbing, while a different service provider (e.g., Jim) may be skilled in lawn mowing, lawn fertilizing, and tree pruning

In one example, minimum fixed pricing may be based on a linear function with the Y intercept being the minimum a service provider is willing to accept for even the smallest task and the slope being the unit price of an incrementally sized task, like square feet of lawn. The minimum fixed pricing may also be based on a non-linear function like a Weibull distribution, where the parameters are defined based on best fit from other data. Examples of other data a service provider may include to find a best fit may be examples as provided by the service provider of the service provider's existing work, hourly pricing, pricing reported by the service provider's customer, other service provider pricing data, national labor statistics, etc.

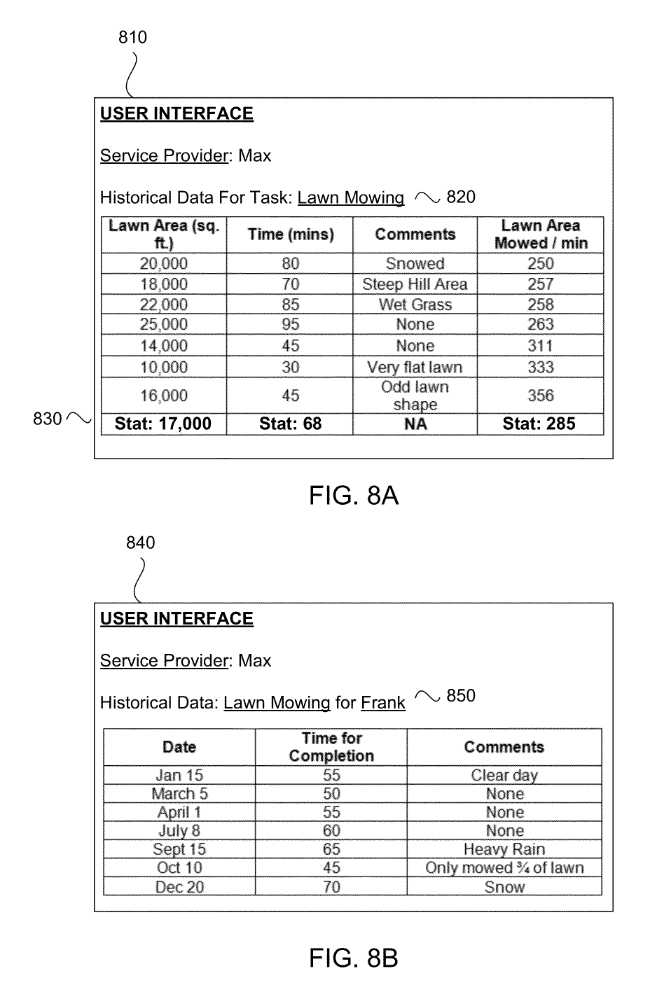

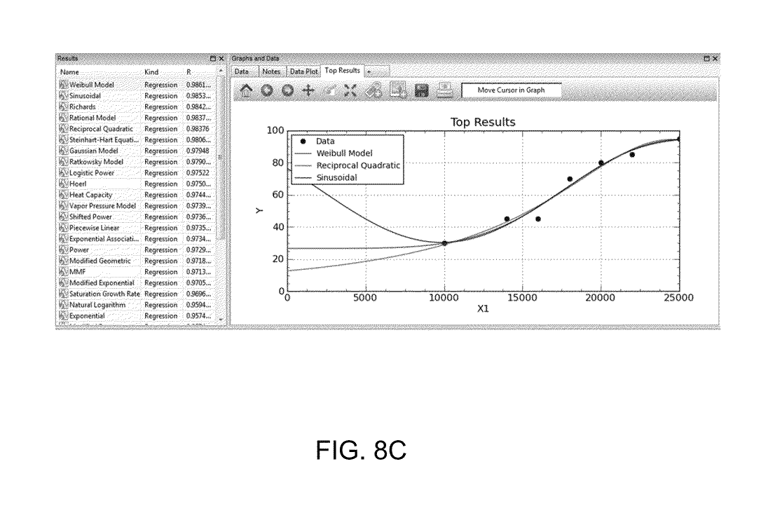

FIGS. 8A and 8B include tables showing example historical completion times for completing scheduled tasks. For example, a customer may purchase a lawn mowing task. Thereafter, an estimated amount of time to complete the purchased task may be determined in order to schedule the task on a scheduling calendar. The exemplary user interface 810 may include historical data for performing a task 820 (e.g., lawn mowing) related to the purchased task. In some examples, the historical data for lawn mowing may include past completion times based on the lawn area. For example, the table may indicate that a 20,000 square foot lawn took 80 minutes to mow. In addition, the table may include comments that describe the tasks (e.g., snowed, steep hill, wet grass), which may explain a higher/lower than average task completion time. In some examples, the table may include a lawn area (in square feet) mowed per minute. In addition, statistical data 830 may be included, such as a statistical lawn area, a statistical task completion time, and/or a statistical lawn area mowed per unit of time. The statistical values may be computed using a mean, average, expected value, best-fit curve, regression, Weibull distribution, or another statistical computation model. In general, the table may be used to estimate a completion time of a purchased task (i.e., a new task) based on similar sizes and/or conditions of the previous tasks.

The exemplary user interface 840 may include historical data for completing a task (e.g., lawn mowing) for a specific customer 850. For example, the table may include the amount of time to mow the customer's lawn the previous seven times. By using this data, an estimated time to mow the customer's lawn may be calculated. In addition, the table may include comments corresponding with the previous tasks (e.g., heavy rain, snow) to describe the conditions when the previous tasks were performed. Generally, the comments may be useful in estimating the amount of time to perform a purchased task with similar conditions as compared to the previous tasks, and may be used by a plurality of services providers. The estimated times may apply to specific types of tasks (e.g., lawn mowing), as well as estimated types of tasks.

FIG. 8c illustrates an example best-fit curve for the various columns of data in FIG. 8A that may be used as a predictive technique for other future tasks. Any of several different best-fit models may be used such as a Weibull model, Reciprocal Quadratic model, Sinusoidal model or another useful best-fit model. The R-value for the Weibull distribution is close to 1 (0.9861) in this example, and is therefore likely a good fit for the data. In this way, for any given value of x (e.g., square feet of lawn), an accurate estimate of y may be produced (e.g., estimated time to mow a lawn). Multi-dimensional best-fit models may be used if there are two or more input columns and this may result in a curve space that estimates the desired time result. Furthermore, accurate variances may be calculated such that conservative time estimates may be produced that will be equal to or greater than the actual time that a task is predicted to consume in up to 95% (or some other tolerance threshold) of the time.

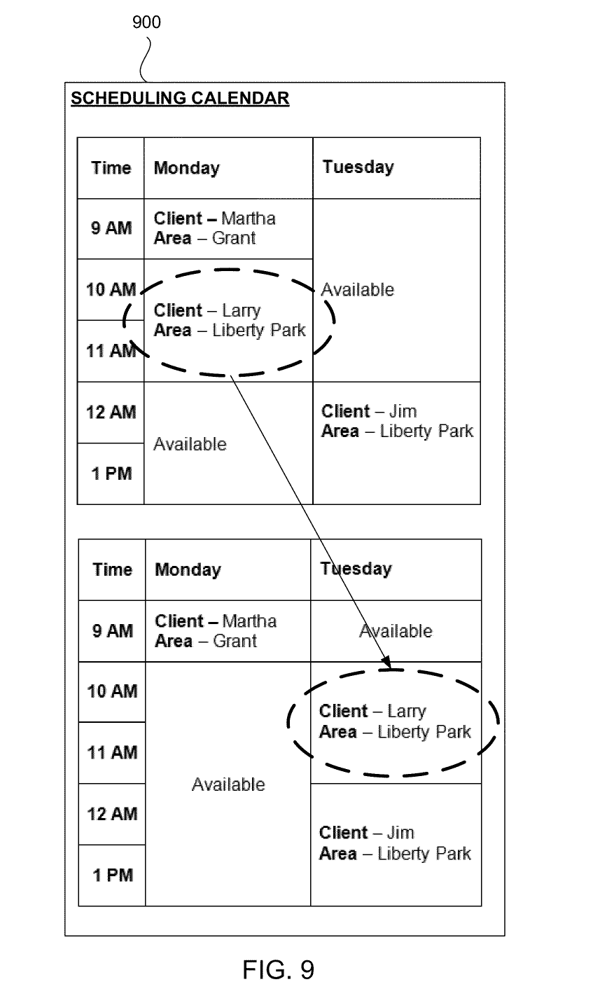

FIG. 9 illustrates an example of moving scheduled tasks within a scheduling calendar 900. In general, scheduled tasks may be moved within an anchor in order to optimize overall travel time associated with performing a collection of scheduled tasks. For example, a service provider (e.g., Max) may be scheduled to perform a scheduled task for Martha on Monday, and may be subsequently scheduled to perform a scheduled task for Larry. Furthermore, the service provider may travel to Grant to perform Martha's scheduled task, and then subsequently travel to Liberty Park to perform Larry's scheduled task. The following day, the service provider may be scheduled to perform a scheduled task for Jim in Liberty Park. Since the service provider is already scheduled to travel to Liberty Park on Tuesday, Larry's scheduled task on Monday may be moved to Tuesday, thereby reducing the traveling time for the service provider. In general, the scheduled tasks may be moved as long as no constraints of the scheduled tasks (e.g., anchors) are violated.

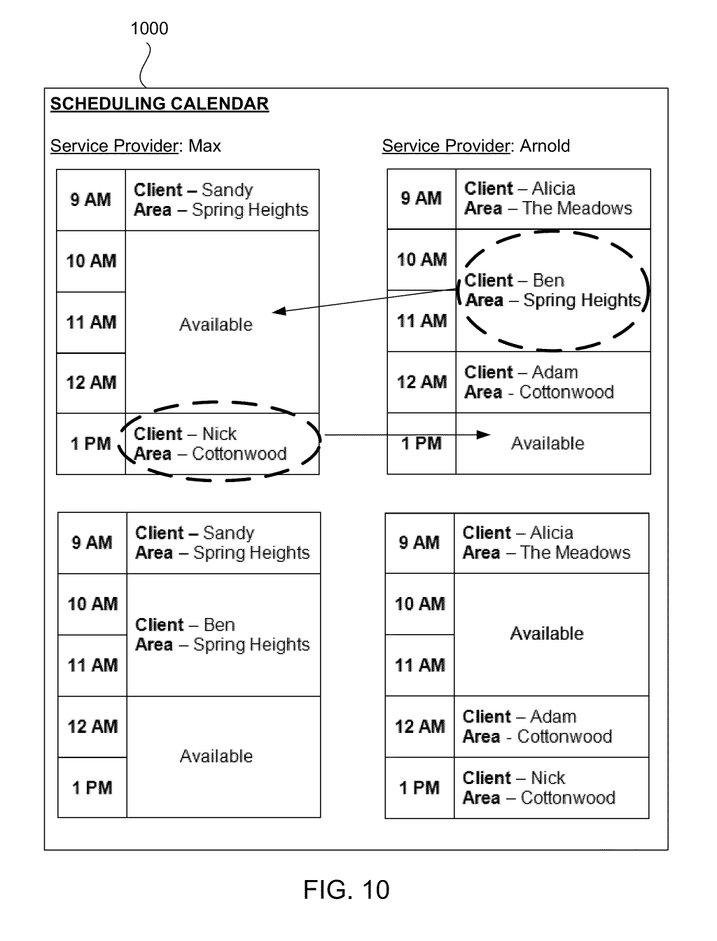

FIG. 10 illustrates an example of reordering scheduled tasks within a scheduling calendar 1000. The scheduled tasks may be reordered by service providers in order to optimize travel times associated with performing the scheduled tasks, as long as no constraints of the scheduled tasks (e.g., anchors) are broken. For example, the scheduling calendar 1000 may indicate that a service provider (e.g., Max) is scheduled to perform a scheduled task for Sandy in Spring Heights. After a three hour break, Max may be scheduled to perform a scheduled task for Nick in Cottonwood. In addition, a different service provider (e.g., Arnold) may be scheduled to perform a task for Alicia in The Meadows, and then subsequently perform a task for Ben in Spring Heights. On the same day, a different service provider (e.g., Arnold) may be scheduled to perform a scheduled task for Ben in Spring Heights, and during a time slot when Max is available. Since Max is already in Spring Heights, it may be desirable to give Ben's scheduled task to Max, thereby reducing the travel times associated with performing the scheduled tasks. In addition, it may be desirable for Max to give Arnold a scheduled task to be performed for Nick, as Arnold may already be in Cottonwood to perform a scheduled task. Thus, by reordering the scheduled tasks, the travel time associated with performing the scheduled tasks may be reduced.

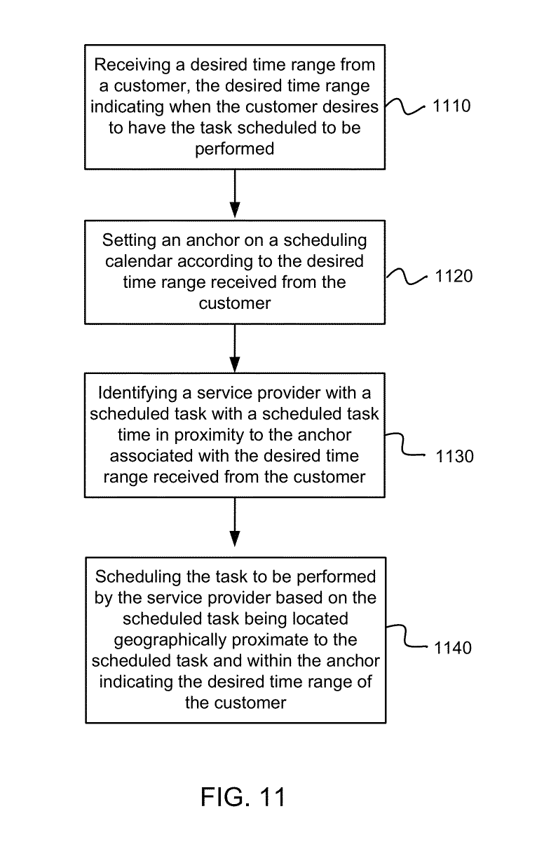

FIG. 11 is a flowchart illustrating an example method for scheduling purchased tasks. The method may include the operation of receiving a desired time range from a customer. The desired time range may indicate when the customer desires to have the purchased task scheduled to be performed, as in block 1110. In addition, the desired time range may indicate a time when by which the purchased task should be completed and/or a time in which the purchased task should be performed. In some examples, a default time range may be used when the customer does not specify a desired time range. For example, a customer (e.g., Sam) may purchase a task to have his windows washed. Sam may desire to have his windows washed within a time range of Sunday to Wednesday. In other words, the time range of Sunday to Wednesday may indicate the desired time range to have the purchased task scheduled to be performed. In addition, the customer may request that the service provider start and finish the purchased task during the desired time range. In addition, the customer may request that the purchased task be finished (or completed) during the desired time range.

An anchor may be set on a scheduling calendar according to the desired time range received from the customer, as in block 1120. The anchor may indicate a time range of when the purchased task is to be performed. For example, Sam may indicate that the windows be washed within the time range of Saturday to Wednesday. Therefore, an anchor indicating that the purchased task be performed on Saturday to Wednesday may be included in the scheduling calendar.

A service provider may be identified that has a scheduled task having a scheduled task time in proximity to the anchor associated with the desired time range of the purchased task received from the customer, as in block 1130. For example, Sam may indicate that his windows are to be washed on Wednesday between 8 AM to 12 PM. In addition, a service provider may be identified that is scheduled to perform a scheduled task on Wednesday at 11 AM. Therefore, the scheduled task has a scheduled task time (e.g., 11 AM) that is in proximity to the anchor set according to Sam's desired time range. In some examples, a service provider may be identified that is scheduled to perform a scheduled task with a scheduled task time within the anchor set to a customer's desired time range. For example, Sam may indicate that his windows are to be washed on Wednesday, and a service provider may be identified that is scheduled to perform a scheduled task on Wednesday afternoon.

In some examples, the service provider may be identified based on a skill level possessed by the service provider to competently perform the purchased task. For example, a service provider (e.g., Arnold) may be skilled in pruning trees and mowing lawns, whereas a different service provider (e.g., Max) may be skilled in washing windows. Thus, purchased tasks involving window washing are unlikely to be competently performed by Arnold, and therefore, Max may be identified as having the skill level to competently perform window washing.

Using another factor, the service provider may be identified based on the service provider's schedule availability. For example, a customer may indicate a purchased task to be performed on Wednesday. A service provider (e.g., Max) may have no availability on Wednesday due to scheduled tasks on Wednesday, whereas a different service provider (e.g., Arnold) may be available on Wednesday to perform tasks. In addition, the service provider may be identified according to a fixed price or parameters for minimum or maximum acceptable pricing for a task. In some examples, the service provider may be identified as working within a predetermined geographical range from the customer. For example, a customer may live in the Pleasant Hill neighborhood, and a service provider's specified service territory may include everything within a ten-mile radius of Pleasant Hill. Because the customer is within the predetermined geographical territory of the service provider, the service provider may be selected to perform this task.

The purchased task may be scheduled to be performed by a specific service provider, as compared to a plurality of service providers, based on being located geographically proximate to an existing scheduled task of that service provider and within the anchor indicating the desired time range of the new customer's purchased task, as in block 1140. For example, a service provider (e.g., Max) may be scheduled to perform an existing scheduled task on a Tuesday morning. In addition, the purchased task may be anchored to Tuesday afternoon based on a desired time range received from the customer. Furthermore, the existing scheduled task may be geographically proximate to the customer's purchased task. Therefore, that service provider may be selected to perform the task, and the purchased task may be scheduled on the calendar next to the scheduled task. In some examples, the customer may be provided with an option to select from available time slots for scheduling the purchased task to be performed. The available time slots may be those considered to be the most efficient as they are temporally next to scheduled tasks that may be geographically proximate to the purchased task for one or more service providers. Further, the purchased task may be scheduled as a recurring task by setting a plurality of anchors on the scheduling calendar corresponding to a recurring desired time range to perform the recurring task.

In some examples, the purchased task may be scheduled on the scheduling calendar to include a travel time associated with the service provider performing the purchased task for the customer. In addition, the travel time may be used as a factor in a proximity calculation. For example, it may take a service provider (e.g., Max) approximately 50 minutes of travel time in order to perform a purchased task for a customer. The 50 minutes of travel time may be determined to not be the substantially most efficient, and therefore, the service provider may not be identified to perform the purchased task for the customer, or the task might be scheduled at a different time with that service provider next to another task that is more proximate.

In another example, a purchased task may be assigned to a service provider who has performed less than a predetermined number of tasks within a predetermined time frame. In other words, a “fairness principle” may be implemented to ensure that one service provider is not assigned a disproportionate number of tasks. The tasks assigned to the service provider within a predetermined time frame may be compared with tasks assigned to a plurality of service providers within the predetermined time frame. Upon determining that the service provider has been assigned fewer tasks or a lower total task weighting as compared to the plurality of service providers, a purchased task may be assigned to the service provider. For example, a service provider (e.g., Arnold) may have performed 25 tasks in the previous month, whereas a different service provider (e.g., Max) may have performed 8 tasks in the previous month. Therefore, a purchased task (i.e., a new task) may be assigned to Max rather than Arnold, in accordance with the “fairness principle.” The task may also be weighted and the task assigned to service providers may be compared based a number of weighted tasks. In general, the “fairness principle” is subservient to the “optimization principal.” (i.e. the system is more biased toward optimization than to fairness, and service providers maybe allowed to receive a disproportionately “unfair” portion of new tasks in the interest of “optimization”).

In some examples, a purchased task to be performed by a service provider may be moved around, within an anchor, in order to optimize a travel time associated with performing the purchased task. In addition, a purchased task desired by a customer may be rearranged with a scheduled task, while obeying the constraints of the anchor, in order to optimize travel times associated with performing one or more existing scheduled tasks and performing the purchased task for the customer.

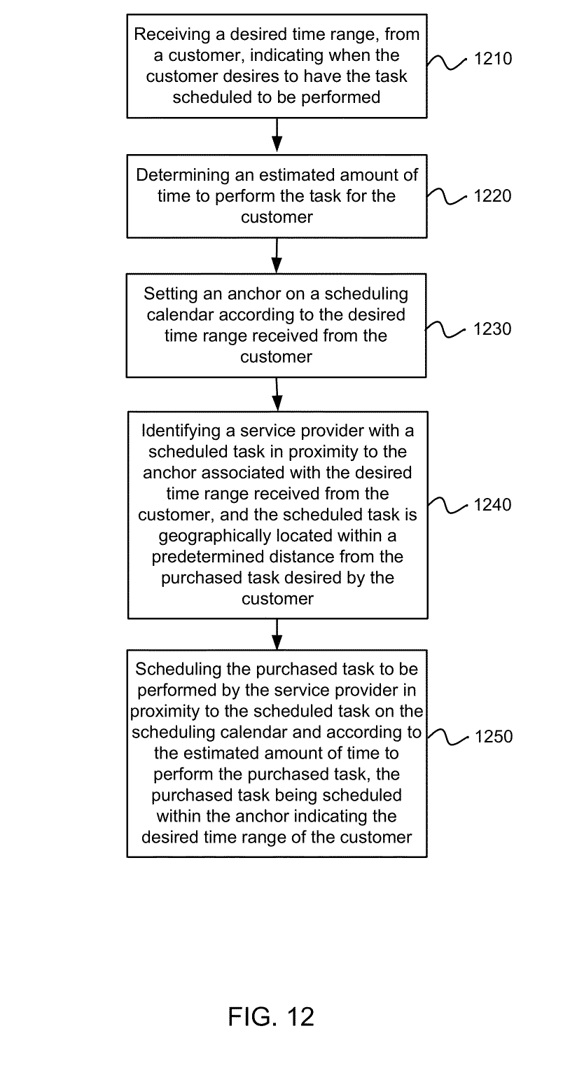

FIG. 12 is a flowchart illustrating an additional example method for scheduling purchased tasks. The method may include the operation of receiving a some number of desired time ranges and parameters (i.e. an anchor), from a customer, indicating when the customer desires to have the purchased task scheduled to be performed, as in block 1210.

An estimated amount of time to perform the purchased task for the customer may be determined, as in block 1220. The estimated amount of time may include a travel time associated with performing the purchased task. The estimated time may be determined by identifying previously performed tasks relating to the purchased task to be performed for the customer, identifying completion times for the previously performed tasks, and determining an estimated amount of time for completing the purchased task for the customer based on the completion times of the previously completed tasks. For example, a customer (e.g., Sam) may purchase a window washing task. The completion times of window washing tasks for homes that are similar to Sam's home (e.g., in size, number of stories) may be used to estimate the amount of time to wash the windows in Sam's home.

In some examples, the estimated amount of time to perform a purchased task may be based on a best-fit time for completing previous tasks related to the purchased tasks. The estimated time may be the best-fit time plus or minus some adjustment for variability, thereby accounting for possible errors when calculating the estimated amount of time. Best-fit models can also be used for pricing for specific geographies to account for regional differences in such things as: local traffic, regional weather differences, legal code and other busywork or paperwork that might be performed by the service provider in one area but not in another, etc.

In more detailed examples, the estimated amount of time to perform a purchased task may be calculated based on a probability distribution. In addition, various probability distributions may be used depending on the type of purchased task. For example, the amount of time to mow a lawn may be estimated using a Weibull distribution. The square footage of the lawn may be an input parameter. Lawns that are relatively smaller in square footage as compared to a plurality of lawns may have a minimum asymptote for the amount of time needed to mow the lawn. The minimum asymptote may be due to the time needed for the service provider to take out the equipment, survey the yard, turn off the sprinklers, clear the toys from the lawn, ensure the equipment is in working order, etc. In addition, lawns that are relatively larger in square footage as compared to the plurality of lawns may have a sloped or non-linear asymptote because as the lawn size increases, the amount of time needed to mow the lawn relative to the lawn size may decrease.

In a further example, a statistical variance may be calculated of the completion times for the previously performed tasks related to the purchased task for the customer. In general, the statistical variance may provide a measure of how the data distributes itself about the mean, average, expected value, or best-fit curve. The estimated amount of time to perform a purchased task for the customer may be determined based on the statistical variance of the completion times for the previously performed tasks. In general, a greater variance may result in a greater range of the estimated amount of time. For example, a calculated variance may result in an estimated time range of 40-60 minutes for performing the purchased task, whereas a calculated variance may result in an estimated time range of 20-25 minutes for performing a different purchased task.

An anchor may be set on a scheduling calendar according to some number of desired time ranges and parameters received from the customer, as in block 1230. The anchor may indicate a time range of when the purchased task is to be performed. For example, a customer may indicate that the lawn be fertilized within a time range of Monday to Thursday. Therefore, an anchor indicating that the purchased task be performed on Monday to Thursday may be included in the scheduling calendar.

A service provider may be identified with a scheduled task in geographic proximity to the purchased task received from the customer, that happens to also be within or adjacent to the anchor associated with the desired time range received from the customer for the purchased task, as in block 1240. In addition, a service provider may be identified based on a volume metric of tasks previously and successfully performed by the service provider, a rating associated with the quality of the service provider's performance of scheduled tasks, a statistical timeliness of a service provider based on scheduled tasks that were previously performed by the service provider, and/or a skill level possessed by the service provider to competently perform the purchased task.

In some examples, the service provider may be identified by analyzing scheduling calendars for a plurality of service providers. The scheduling calendars may indicate available time slots without currently scheduled tasks. Available time slots should also account for the possible flexibility of moving scheduled tasks, according to their anchors, to other times. A service provider may be identified that has an available time slot that corresponds to a desired time range indicated by a customer. For example, a customer may purchase a task to be completed on Friday afternoon. By analyzing the scheduling calendars for the plurality of service providers, 5 service providers may be identified that are available to perform the purchased task on Friday afternoon. Additional factors may also be used to select the service provider including a service territory of the service provider, a skill level of the service provider, service provider pricing, or a proximity of a purchased task to existing scheduled tasks assigned to service provider. Once these service provider factors are taken into account, a service provider may be assigned the purchased task from the pool of 5 service providers that are available.

The purchased task to be performed by the service provider may be scheduled in proximity to the scheduled task on the scheduling calendar and according to the estimated amount of time to perform the purchased task, with the purchased task being scheduled according to the constraints or parameters of the anchor indicating the desired time range of the customer, as in block 1250. For example, a service provider (e.g., Max) may be scheduled to perform a scheduled task from 11 AM to 2 PM, based on an estimated time of 3 hours to perform the scheduled task. The method of the present technology can also assist in assigning the purchased task to a time slot currently being used by a scheduled task. Scheduling calendars for a plurality of service providers can first be analyzed, and the scheduling calendars may indicate time slots occupied by scheduled tasks. Then a service provider may be selected with a scheduled task in an occupied time slot that falls within the anchor for the purchased task. The scheduled task can be moved to another calendar time (within the constraints of the scheduled task's own anchor) to improve schedule efficiency. The purchased task may then be scheduled in the previously occupied time slot. In other words, the purchased task can be scheduled in a time slot already occupied by other tasks in the interest of efficiency by moving the other tasks, according to their anchors, to another location.

In addition, the scheduling calendar may be optimized by applying a genetic method to the scheduling calendar. The genetic method may include a genetic representation of a solution domain, and a fitness function to evaluate the solution domain. In some examples, the genetic representation may be the scheduling calendar. In addition, the fitness function may be used to measure the quality of the represented solution. In some examples, the fitness function may be an estimated profit of the service provider for completing the tasks. In other words, an optimized scheduling calendar may result in increased estimated profits for the service providers. In some examples, the fitness function may include the proximity of tasks being performed by the assigned service provider, the flexibility to further optimize the scheduling calendar based on the desired time range provided by the customer, and/or the statistical variance of the estimated times to perform the tasks.

In another example, a service provider may restrict the anchor in order to accommodate a specific scheduling objective. For example, where 20 tasks are assigned to a service provider and the 20 tasks are optimized in relation to both task proximity to one another and the anchors prescribed by the customers or by default. Suppose the service provider realizes he needs to stay late and work late one day because he expects rain the next day will prevent him from performing work. The service provider might constrain the system to force one or more tasks to have a less optimized anchor (either temporarily or permanently) in order to shuffle tasks around. This may visually appear as though the service provider is “pinning” the task to an unnatural or less efficient time slot. If the constrained task is a recurring task, a visual indicator may be provided to show that the task is constrained by the service provider to remind the service provider to eventually remove the artificial constraint, or the service provider may be allowed to pin just one instance if the recurring task. In another example, a customer may have a recurring task performed on a Friday, but the customer may call the service provider and ask if the task can be moved to Thursday this one time. The service provider may apply a one-time override to the regular anchor and a temporary or one time more restrictive anchor may be applied to one instance of the task.

### Rescheduling

Rescheduling a task may occur at any time, and may be initiated by a customer, a services provider or a system (where the system may automatically receive new data or may observe some behavior that allows the system to recognize the need for rescheduling). In general, rescheduling may be similar to scheduling and many of the concepts and formulas described under the scheduling section may be referenced herein.

In the context of rescheduling “anchor” may further refer to a specified time, or time range, or set of constraints for performance of a task. Furthermore, anchors can be a single time occurrence or can be a series of repeating occurrences. An anchor may be different than a scheduled task in that an anchor may be generally temporally greater than or equal to the scheduled task in order to allow the scheduled task to move about within the anchor for increased flexibility in scheduling.

In the context of rescheduling, “scheduled task” may further refer to all of the specific details and temporal estimates related to the performance of an actual task. A scheduled task may be different than an anchor in that a scheduled task may be allowed to move about within the anchor freely to achieve increased flexibility in scheduling. Furthermore, a scheduled task may be an estimate of the actual time and a specification of the actual details to perform a task.

As used herein, “resolution” may refer to specified criteria through which qualifying data may be identified or viewed. In one aspect, criteria may be a level of detail. In another aspect, criteria may be a measure or window of time. In yet another aspect, criteria may be inclusion of a specifically desired activity, element, event, occurrence, or opportunity. In a further aspect, a combination of the foregoing criteria may be used

In some respects, resolution may define the degree of flexibility the system may use when rescheduling a task so that the system may identify schedule options that may result in a service provider schedule that may be optimally or substantially maximally efficient. In order to illustrate the concept, resolution may be likened to a camera lens zoom, or image resolution where one times resolution may be equivalent to a task's original anchor. Two times resolution might divide a task's original anchor into two equal temporal periods and display a schedule efficiency impact for choosing to reschedule the task on either of the two periods. Seven times resolution might divide a task's original one week anchor into seven days and display the schedule efficiency impact for choosing to reschedule the task on one of those seven days. Generally one of these selections may have no immediate schedule efficiency impact as it may simply cause the task to be rescheduled to the same substantially maximized efficient time where it was scheduled before being rescheduled.

Examples of resolution may include, a resolution that may be equal to the original or existing anchor less some portion of the original or exisignt anchor, a resolution that may be equal to the original or existing anchor divided into some number of periods but only displaying periods that fall within the original or existing anchor, a resolution that may be equal to the original or existing anchor but the system is displaying future instances of that anchor, or a resolution that may be equal to the original or existing anchor divided into some number of periods but also displaying increments of those periods that are part of future instances of that anchor.

Rescheduling may be done continuously and automatically by the system according to the established and/or existing anchors and according to new inputs or system observations. For example, if the system has scheduled a set of tasks for the current day for a service provider, but then observes that one of the tasks has not been started when it was originally scheduled, the system might, in some aspects, automatically begin to delay the task and all other subsequent tasks, according to the task's best-fit according to the task's anchors. For example, a service provider may wake up late one day after the service provider should have already completed two tasks. All of the tasks for the day may be automatically and continuously adjusted to accommodate an anticipated start time as early as “now.” In some cases, this may mean that tasks “leapfrog” as a task scheduled for later in the day due to efficiency, may not be able to slip any later in the day or to a different day due to its existing anchor. In other cases, all of the tasks may move to later in the day until the tasks begin to push up against the end of the day as specified by the services provider's availability.

Some tasks may operate almost exclusively according to a rescheduling paradigm. For example, snow clearing may not be necessary until and unless it snows some minimum amount. When this occurs, the system may automatically reschedule these tasks for an optimal time according to the task's anchors that were originally established.

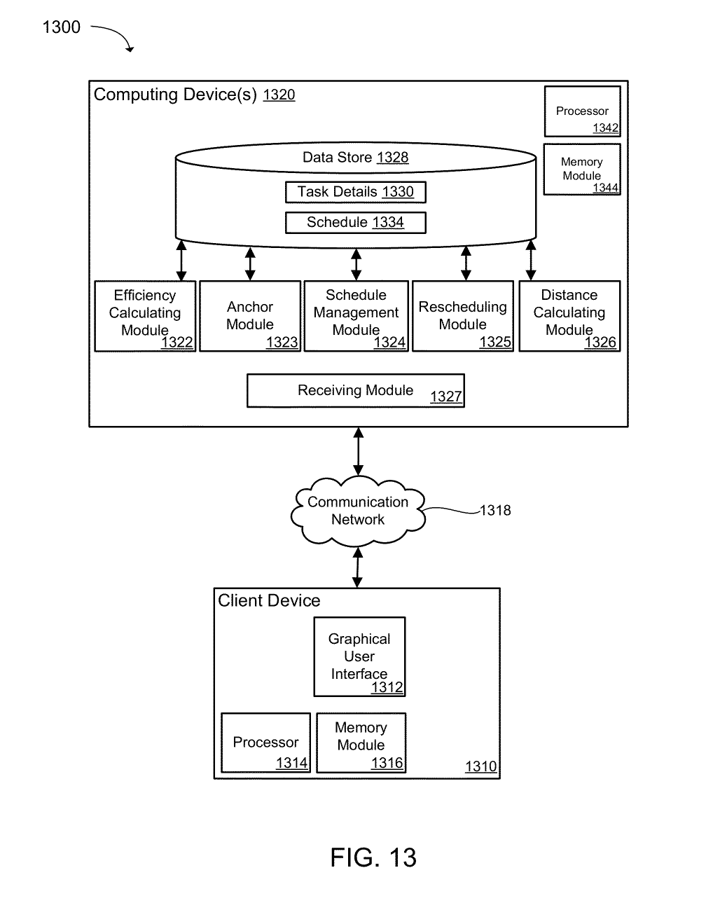

As illustrated in FIG. 13, a system may be used for substantially maximizing travel efficiency of a service provider's schedule of tasks upon rescheduling a task in the service provider's schedule. The system environment 1300 may include a computing device 1320 that may be accessed over a communications network 1318 via a client device 1310. Various processes and/or other functionality may be executed in the system environment 1300 utilizing one or more data store(s) 1328 and processing modules. A data store 1328 may include task details 1330 and service provider schedules 1334. Task details 1330 may include any information associated with a task, such as the task's temporal location (i.e. time and date on the schedule), task type, task location, estimated time to perform the task, etc. Service provider schedules 1334 may be an individual schedule of tasks for a service provider, or may be a schedule of tasks for a group or organization of service providers. Processing modules may include a receiving module 1327, an efficiency calculating module 1322, an anchor module 1323, schedule management module 1324, a rescheduling module 1325 and a travel requirement module, such as a distance calculating module 1326.

Rescheduling an existing task may occur under a number of different circumstances. For instance, rescheduling a task may be initiated by a customer, or by a service provider, or by the system, (e.g., the system received a new task affecting the schedule, causing other tasks to be rescheduled automatically for efficiency reasons. Or, an automated process, such as a weather system, or a GPS tracking system tracking the current location of the service provider, recognized a need for rescheduling). The receiving module 1327 may receive from a customer, service provider or the system a resolution for an existing task to be rescheduled. A resolution may specify experimental criteria through which possible anchor assignments are evaluated for their potential impact on the overall schedule efficiency. In one aspect, the criteria may be a level of detail. In another aspect, the criteria may be a measure or window of time. In yet another aspect, the criteria may be inclusion of a specifically desired activity, element, event, occurrence, or opportunity. In a further aspect, a combination of the foregoing criteria may be used. Upon receiving a resolution, the receiving module may make the resolution available to other modules and/or data stores within the system environment 1300.

In one example, an anchor module 1323 may be configured to identify anchors for a number of tasks in a service provider's schedule and set an alternate anchor for the task to be rescheduled that might be based upon the resolution received by the receiving module 1327. For example, a resolution may be received from a service provider that may be for a window of time equal to a work day. The service provider may wish to reschedule a task from 9 AM to 3 PM within the work day. The anchor module 1323 may identify the anchor for the task that the service provider would like to reschedule and then set an alternate anchor for the task. Thus, the anchor module 1323 may identify the task's existing anchor, which may be 7 AM to 5 PM (i.e. one work day) and then set a new or alternate anchor of 1 PM to 3 PM. In addition, the anchor module 1323 may identify a number of anchors for tasks that a service provider may wish to reschedule and then set alternate anchors for each of the number of tasks. In an alternative embodiment of the invention, particularly when rescheduling is initiated and driven by the system itself, the scheduled task may be moved within the existing anchor as needed without establishing a new or alternate anchor. In some aspects, the task may be moved multiple times within the existing anchor. If there comes a point where the task would have to be moved out of the existing anchor, or if the entire existing anchor were unusable for some reason (for example another task is now schedule in a portion of the anchor, or a portion of the anchor is now expired), then an alternate anchor for the task to be reschedule may be established. Further, in some regards, the processing system may prepare an alternate anchor each time the existing task is rescheduled, but the alternate anchor may match exactly the existing anchor when there is no reason for the alternate anchor to be different from the existing anchor, as in the example illustrated above.

In another example, an anchor module 1323 may identify anchors for a number of tasks in a service provider's schedule and allow anchor adjustments for tasks. There may be instances where a task may be rescheduled within the task's existing anchor and an alternate anchor may not be needed (as mentioned above). For example, adjustment to task times only within the task's respective anchor may be needed due to a rain delay. Or a portion of a task's anchor may be disqualified due to the passage of time and the task time may be adjusted to a portion of the task's anchor that may still be valid.

An efficiency calculating module 1322 may be configured to determine an efficiency of a service provider's schedule if the task to be rescheduled were to be relocated to a different time on the service provider's schedule. In one example, using the alternate anchor that may be set by the anchor module 1323, the efficiency calculating module 1322 can calculate a schedule of tasks that may substantially maximize a service provider's time by substantially maximizing travel efficiency. To accomplish this, the efficiency calculating module 1322 may calculate a number of permutations of schedules using a random-path genetic fitness function or other statistical methodology.

In determining schedule efficiency, a cumulative amount of time or distance that may be needed to move from one task location to another task location between task locations in a schedule may be considered. In some aspects, the distance calculating module 1326 may determine the distance between each task location, the travel time required between each task location, and/or the travel-related cost (such as monetary cost or savings), along with any other travel requirements, and may make the results available to the efficiency calculating module 1322. The arrangement of tasks within a schedule may be rearranged in order to find an arrangement that results in the greatest efficiency, as measured by one or more of the above-recited factors, such as the smallest amount of time or distance expended by a service provider to travel to and from tasks. Each arrangement of tasks within the schedule may abide by an anchor for each task in the schedule. For example, if a task has an anchor of 9 AM to 5 PM, the task may be scheduled for anytime between 9 AM and 5 PM, but may not be scheduled for a time outside of the task's anchor. The permutation that may result in the smallest amount of time or distance between tasks may be considered the most efficient schedule.

A schedule management module 1324 may arrange time ranges for tasks within the service provider's schedule according to the schedule determined by the efficiency calculating module 1322. The schedule management module 1324 may adjust a time range for a task that is in proximity to a rescheduled task on a schedule. The adjustment of the task's time range may be within an anchor associated with the time range to perform the task. For example, a first task that may take an hour to perform may be rescheduled to a time that may be in schedule proximity to a second task that may take thirty minutes to perform, it may be necessary to adjust the time range for the second task to accommodate the rescheduling of the first task. For instance, if the first task is rescheduled to 9 AM and the second task was previously scheduled for 9:30 AM, and the estimated travel time for the service provider to travel from the first task to the second task is 18 minutes, the time range for the second task may be adjusted to 10:18 AM to 10:48 AM to allow for a time range of the first task to be performed between 9 AM to 10 AM, and to allow for the travel time of 18 minutes. Where the originally established anchor for the second task includes the extra time period from 10:18 AM to 10:48 AM, and where this particular schedule change results in the substantially most efficient travel schedule given the constrains of all anchors for all effected tasks, the schedule change may be provided by the schedule management module 1324 to the system.

Adjustments made by the schedule management module 1324 to a task's scheduled time may be made automatically at any time provided the changes are within the anchor associated with the task, and provided that they are made in an effort to increase overall efficiency. A task's anchor, as explained earlier, may have a number of time ranges and parameters associated with the anchor. In this example, a first task may have an anchor that may be a time range of 8 AM to 12 PM and a second task may have an anchor of 9 AM to 1 PM. If the first task were to be rescheduled, the rescheduled time may fall within the first task's anchor, sometime between 8 AM to 12 PM. Thus, if the first task is rescheduled for 9 AM, the rescheduled time range for the task falls within the first task's anchor (i.e., 8 AM to 12 PM). The second task may have been scheduled for 9 AM, but now may need to be adjusted to accommodate the rescheduled first task. Because the first task may take an hour to perform, and the travel time between the first task and the second task may be 18 minutes, the second task's time range may be moved to 10:18 AM, which may be within the second task's anchor of 9 AM to 1 PM. The schedule management module 1324 may perform the same process for every task within a service provider's schedule that may be in temporal proximity with another task. After the schedule management module 1324 may have provided a schedule change to the system, a rescheduling module 1325 that may be configured to reschedule a task, may then apply the schedule changes provided by the schedule management module 1324 to a service provider's schedule. In one example, where a resolution may have been received by a service provider, the service provider may select the schedule provided by the schedule management module 1324 and the rescheduling module 1325 may then apply the changes to the service provider's schedule. In another example where the resolution may have been received by the system, the system may accept the schedule provided by the schedule management module 1324, or the schedule may be automatically accepted and the rescheduling module 1325 then may apply the changes to the service provider's schedule.

A client device 1310 through which a user (e.g., service provider or customer) can access information related to tasks and customers over a communications network 1318. A graphical user interface 1312 can be provided to the user using the client device 1310 to access the task, customer, and related information located on a separate computing device 1320. A client device 1310 with a graphical user interface 1312 may be used by either a service provider or a customer.

A resolution may be received by the graphical user interface 1312 of the client device 1310. For example, the service provider or the customer may type, speak, write, or select task parameters that the client device 1310 can capture. The client device may include a processor 1314 and a memory module 1316.

The resolution for a rescheduled task may be collected by the client device 1310 and may be sent to a computing device 1320. The computing device 1320 may be a single server, a distributed server environment, a server farm, or any computing device or group of computing devices that may service requests from other computing devices or programs. In addition, the computing device may include one or more processors 1342 and memory modules 1344.

Various processes and/or other functionality may be executed in the computing environment 1300 according to various examples. Also, various data may be stored in a data store 1328 that may be accessible to the computing device 1320.

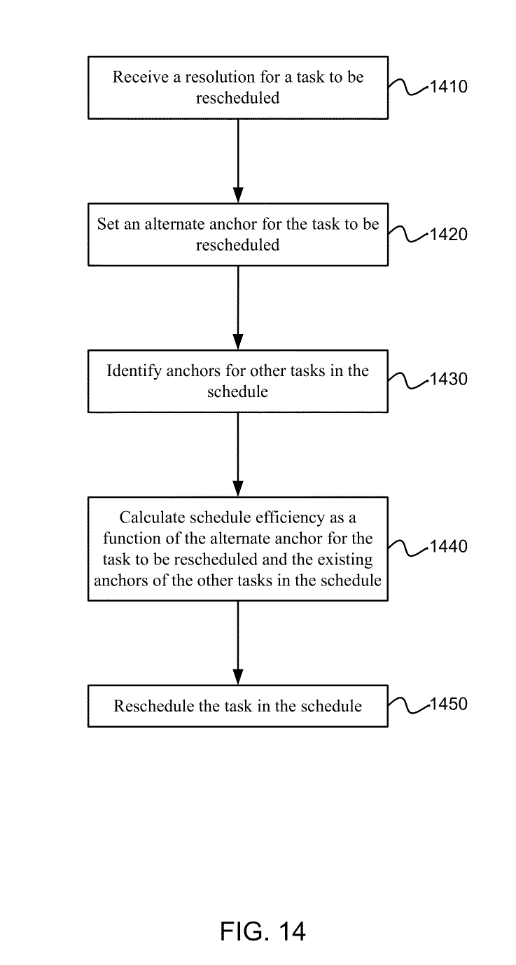

FIG. 14 illustrates an example method for substantially maximizing travel efficiency of a service provider's schedule of tasks upon rescheduling a task. In block 1410 a resolution for a task to be rescheduled may be received from a service provider, a customer, or an automated routine on system hosting a schedule of tasks. In one example, a resolution may be equal to subset of a service provider's schedule of tasks in which the task to be rescheduled may be placed. Examples of subsets of a service provider's schedule of tasks may be subsets that may be equal to a day, a half day, a week, a half week, several days, an number of hours on a specific day, a month, several months, or another desired temporal division of the service provider's schedule. As will be appreciated a resolution may be equal to any of the definitions described earlier. In an alternative embodiment of the invention, a resolution may be equal to one or more temporal divisions of the original anchor for the task, representing periods into which the task might be rescheduled. Examples of temporal divisions of the original anchor might be: a day, a half day, a week, a half week, several days, an number of hours on a specific day, a month, several months, or another desired temporal division of the service provider's schedule. Even though the temporal divisions might be based on the original anchor, the resolution might include periods of time that are outside of the original anchor so that efficiency experiments can be performed that might violate the original anchor constraints. For example, where a service provider may wish to see a resolution that may represent a work day as blocks of time of every 3 hours, the service provider may be provided with a display that may show what may happen if a task were rescheduled for either 8 AM to 11 AM; 11 AM to 2 PM; 2 PM to 5 PM; or 5 PM to 8 PM.

In one example, a resolution may be received from a service provider that may wish to reschedule a task. The service provider may reschedule a task for any reason and may experiment with a resolution based upon a window of time for which the service provider wishes to reschedule the task. A service provider may experiment with a resolution that may be within a task's anchor. By experimenting with a resolution within a task's anchor, a task may be rescheduled so that the task may be performed within the original time specified by a customer. In another example, a resolution may be experimented with by a customer. Like service providers, customers may reschedule a task for any reason and may in some cases have the flexibility in establishing a new anchor for the task by experimenting with a resolution that may fall outside of a task's anchor. This may be because in some cases a customer may have the authority to redefine the parameters of a task. In yet another example, a resolution may be experimented with by an automated routine on a system. In a case where a system may reschedule tasks, such as snow plowing, the system may monitor weather forecasts and choose a resolution based upon expected snowfall for that window of time.

As in block 1420, an alternate anchor for a task to be rescheduled may be set. The alternate anchor may be set within the task's established anchor based upon the resolution. For example, for a task that may have an established anchor of a time between Wednesday and Friday, an alternate anchor may be set anytime within the anchor. A resolution of 1 day may be experimented with between Thursday and Friday allowing for an alternate anchor to be set for either Thursday or Friday. If an alternate anchor is set for Thursday, the task may be scheduled for the most efficient time on Thursday. In a further example, a task's anchor may be a time between Wednesday and Friday and a resolution may be experimented with for half-week periods, in this case a time between noon on Wednesday and end-of-day on Saturday. Because the resolution may be for a larger window of time than that of the task's anchor, an alternate anchor may be constrained to the resolution's window of time that falls within the task's anchor, namely anytime between Wednesday and Friday, or it might violate the original anchor, and either seek the customer's permission or provide the customer with notification that the original anchor was violated.

As in block 1430, anchors for other tasks in the service provider's schedule may be identified for the purpose of calculating a schedule. Rescheduling a task may affect other tasks within a service provider's schedule. This may be because a rescheduled task may cause other tasks to shift or move within the service provider's schedule in harmony with the constraints established by their respective anchors. The anchors for tasks that may be in temporal proximity to a rescheduled task, and therefore may be subject to shifting or moving within the schedule, may be identified allowing for a calculation of an efficient schedule that may take these anchors into account.

Based upon the alternate anchor for the rescheduled task and the anchors for other tasks, a schedule may be calculated. As in block 1440, calculating schedule efficiency may be accomplished as a function of the alternate anchor for the task to be rescheduled and the existing anchors of the other tasks in the schedule. As in the discussion of scheduling earlier, the term “schedule efficiency” as used herein may be defined as the cumulative amount of time or distance traveled to move from task to task in a service provider's schedule, or some other measurement (i.e. fuel costs) that is indicative of efficiency. The arrangement of tasks which results in the smallest amount of time or distance traveled, or costs by a service provider may be considered the most efficient schedule. Calculating schedule efficiency for a rescheduled task may be similar to the process explained earlier for scheduling tasks and the example set of rules provided earlier may be referenced for the purpose of this discussion.

In one example, schedule efficiency may be calculated for all available times within a subset of a service provider's schedule. By including all available times within a subset of the service provider's schedule, schedule efficiency may better take into account the number of possibilities, or permutations that may result in the most efficient schedule. A subset may be any portion of a service provider's schedule, although a window of time that may be sufficiently large may provide for a number of permutations that may result in a more efficient schedule than that of a small subset. In addition, a subset that may include a window of time that may be overly large may result in diminishing returns and may pose a burden to system resources. In an alternative embodiment of the invention, schedule efficiency may be calculated for the performance of all tasks within a subset of a service provider's.

In another example, schedule efficiency may be calculated for available times that may include times within an anchor of other tasks in the schedule. To illustrate, a first task estimated to take an hour to perform may have an anchor of 9 AM to 12 PM and performance of the first task may be currently scheduled for 10 AM to 11 PM. In calculating schedule efficiency and keeping in compliance with the example set of rules provided earlier, a rescheduled task may be rescheduled for a time within the first task's anchor that may not already be occupied by the first task. Thus, in this example the task to be rescheduled may be scheduled for anytime between 9 AM and 10 AM, or anytime between 11 PM and 12 PM (allowing for travel time). In addition, other tasks may be allowed to move within the constraints of those task's respective anchors in determining substantially maximum efficiency. Continuing the previous illustration, a task to be rescheduled may be rescheduled for anytime within the first task's anchor (9 AM to 12 PM) provided there is still room for the first task to move to another time within the first tasks original anchor. The result may be that the task to be rescheduled may be scheduled within the first task's anchor, and the first task may be pushed from 10 AM to 11:18 AM (if the travel time from the rescheduled task to the first task were 18 minutes). In an alternative embodiment of the invention, schedule efficiency may be calculated for tasks that may include tasks presently scheduled within the anchor of the task to be rescheduled.

Another example of schedule efficiency may be where schedule efficiency may be calculated for available times that do not include times within an anchor of other tasks in the schedule. In this example, a task's anchor may act as a boundary to a rescheduled task and therefore times available to reschedule a task may be those times that exist outside of another task's anchor. For example, where a first task may have an anchor of 9 AM to 11 AM and a second task may have an anchor of 1 PM to 3 PM, a rescheduled task may be rescheduled for a time that does not fall within (or at least not entirely within) either or the first task's or second task's anchors. However, it may be determined that the rescheduled task might be efficiently scheduled adjacent to or between the first and second tasks. For example, the task to be rescheduled may have a three hour performance duration, the travel time from the first task to the task being rescheduled may be 25 minutes, and the travel time from the task being rescheduled to the second task may be 35 minutes. The first task might be scheduled to occur from 9 AM to 10 AM, followed by 25 minutes of travel time. The rescheduled task might be scheduled from 10:25 AM to 1:25 PM, followed by 35 minutes of travel time. And the second task might be rescheduled from 2 PM to 3 PM. In an alternative example of the invention, schedule efficiency may be where schedule efficiency may be calculated for tasks that do not include tasks within an anchor of the task being rescheduled.

In another example, schedule efficiency may be calculated where available times include only times within an existing anchor for the task being rescheduled. For example, a service provider may wish to see schedules for a task based upon a resolution that could violate a tasks anchor. In this example, the schedule efficiency calculation may be constrained by a task's anchor and may therefore only show the service provider a schedule that adheres to the task's anchor. To illustrate, a task that a service provider may wish to reschedule may have an existing anchor of Monday to Friday, and the resolution received from the service provider may be for Thursday to Sunday. In calculating a schedule efficiency, the method may use the available times of the resolution and the task's anchor that do not fall outside of the task's existing anchor (i.e., Thursday to Friday). Schedule efficiency may be presented to a service provider or customer by identifying the efficiency impact that various time interval choices (i.e., resolution) might have on an overall schedule, and one or a combination of those time intervals may be selected by the service provider or customer for either resolution experimentation, or to adjust an existing anchor. If a new anchor is established, the task, as in block 1450, may be rescheduled in the service provider's schedule. In another example, a time selected for the task to be rescheduled may be selected using a processor to identify a time within a service provider's schedule that results in the greatest efficiency as compared to other times within the service provider's schedule, while complying with the anchor for that task. For example, the system may select a schedule that may substantially maximize the efficiency of a service provider's schedule of tasks, or in other words, the schedule that best maximizes a service provider's travel efficiency, and the system then may reschedule the task based upon that schedule.

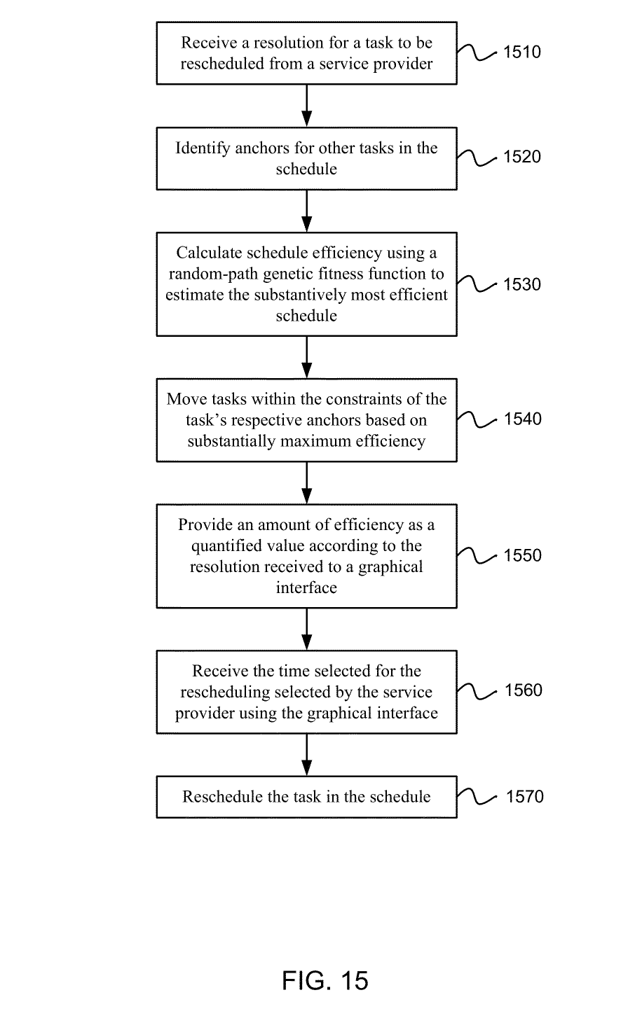

FIG. 15 illustrates an additional example method for substantially maximizing travel efficiency of a service provider's schedule of tasks upon rescheduling a task in the service provider's schedule where a resolution may be experimented with by a service provider as in block 1510. In this example, various resolutions for a task to be rescheduled may be experimented with by a user, such as a service provider, using a graphical interface. A graphical interface may be any device capable of sending and receiving information and displaying the information to a user.

In block 1520, anchors for other tasks in the service provider's schedule may be identified. In block 1530, a random-path genetic fitness function or some other statistical method to estimate the substantively most efficient schedule may be used to calculate schedule efficiency. In some cases of rescheduling a task, the number of permutations of possible arrangements of scheduled tasks to accommodate insertion of the rescheduled task may be large and computationally expensive or infeasible. For this reason, a random-path genetic fitness function or some other statistical method may be used to determine a schedule that approximates the best schedule. In other words, the random-path genetic fitness function or some other statistical method may be used to optimize a scheduling calendar of the service provider. A description and discussion of a random-path genetic fitness function and other statistical methods were detailed earlier and may be referenced therein.

A component in determining schedule efficiency for a rescheduled task may include the travel requirements of a service provider. In one example, a change in efficiency upon rescheduling a task may be determined by calculating a change in travel requirements between one or more tasks. A travel requirement may include travel time, travel distance, or travel-related costs, such as monetary costs, to name a few. In an example where a travel requirement may be travel time, a travel change calculation may include factors such as, but not limited to: distance, traffic data, road data, weather condition data, or combinations thereof. In another example where a travel requirement may be travel distance, a travel distance change calculation may include, but not limited to either distance according to established roads, or direct distance without regard to roads, or a combination thereof.

As in block 1540, based upon schedule efficiency calculated in block 1530, tasks may be moved within the constraints of the task's respective anchors. For example, if a schedule efficiency calculation finds that a service provider's schedule may be more efficient if a task were moved to another time within the task's anchor, the task may be moved to a new time within the anchor. This may benefit other tasks that may be in geographic proximity to the task. For instance, where a first task may be estimated to take an hour to perform and has an anchor of two hours, the first task may be moved within the anchor to a time that may allow a second task in geographic proximity to occupy an hour block of the first task's anchor, thus minimizing travel distance and maximizing efficiency.

As in block 1550, an amount of efficiency that a schedule arrangement may offer to a service provider according to one or more resolution experiments may be provided as a quantified value to a graphical interface. In one example, multiple resolution experiments may be received from service provider using a graphical interface. For each resolution received from the service provider, an amount of efficiency as a quantified value for all of the time intervals specified by that resolution may be provided to the graphical interface. For example, a service provider may wish to see a quantified value of efficiency for a resolution for each week over a 4 week period, each half week over a 4 week period, and/or each day over a 1 week period. The method may provide an amount of efficiency for each of these resolutions for the service provider to choose from.

As in block 1560, based upon a resolution, a block of time selected by a service provider using a graphical interface may be received. For example, a service provider may wish to see schedule efficiencies for a number of different resolutions. An amount of efficiency may be provided to the service provider for each resolution designated by the service provider via a graphical interface. The service provider, using the graphical interface, may select one of the blocks of times associated with one of the resolutions and corresponding amounts of efficiency to establish a new anchor based on that block of time and, as in block 1570, a task may be rescheduled according to the new anchor based on the block of time selected by the service provider. It will be appreciated that resolutions and blocks of time may be received from and quantified values of efficiency may be provided to persons other than service providers via a graphical interface.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for scheduling a purchased task, the method comprising:
under the control of one or more computer systems configured with executable instructions:
receiving a defined time range and parameters for when the purchased task is to be performed;
setting an anchor on a scheduling calendar according to the defined time range and parameters received;
estimating a task duration to perform the purchased task;
identifying one or more service providers that are qualified to perform the purchased task according to the anchor and for the task duration;
selecting one of the service providers based on a calculated schedule efficiency as a function of the anchor of the purchased task with respect to the scheduled anchors of scheduled tasks for each service provider; and
assigning the purchased task to a selected service provider at an efficient schedule time.

2. The method as in claim 1, further comprising
determining a task location for the purchased task; and identifying a service provider based on the task location.

3. The method as in claim 1, further comprising identifying one or more service providers that are geographically eligible.

4. The method as in claim 1, further comprising identifying a service provider with a scheduled task having a scheduled task location in geographic proximity to the purchased task.

5. The method as in claim 4, further comprising:
determining whether the scheduled task is geographically located within a predetermined distance of the purchased task defined by the customer; and
scheduling the purchased task to be performed by the service provider based on the purchased task being located within the predetermined distance of the scheduled task on the scheduling calendar and based on a time proximity to the scheduled task time.

6. The method of claim 5, wherein determining whether the scheduled task is geographically located within a predetermined distance of the purchased task further comprises determining whether the scheduled task is within a specified maximum distance of the purchased task.

7. The method as in claim 4, wherein a geographic proximity of a scheduled task is defined based on a travel cost, drive time between the purchased task and the scheduled task, drive distance between the purchased task and the scheduled task, or a shortest line on a map between the purchased task and the scheduled task.

8. The method of claim 1, further comprising assigning the purchased task to the service provider who has been assigned fewer than a predetermined number of tasks within a predetermined time frame.

9. The method of claim 1, further comprising:
comparing tasks assigned to the service provider within a predetermined time frame with tasks assigned to a plurality of service providers within the predetermined time frame; and
determining that the service provider has been assigned a number of tasks that is less than the any of the plurality of service providers; and
assigning the purchased task to the service provider.

10. The method of claim 1, wherein identifying one or more service providers further comprises identifying a service provider possessing a skill level to competently perform the purchased task.

11. The method of claim 1, wherein identifying one or more service providers further comprises identifying the service provider able to perform the purchased task at or below a pre-determined price.

12. The method of claim 1, wherein identifying a service provider further comprises identifying the service provider within a predetermined geographical range of the customer.

13. The method of claim 1, further comprising:
calculating a travel time associated with the service provider performing the purchased task for the customer; and
scheduling the purchased task on the scheduling calendar by including the travel time associated with the service provider performing the purchased task as a factor for the time duration of the purchased task.

14. The method of claim 1, further comprising scheduling the purchased task to be performed as a recurring task by setting a plurality of anchors on the scheduling calendar corresponding to a recurring time range to perform the recurring task.

15. The method of claim 1, wherein an anchor specifies that a purchased task has a finish time by which the purchased task is to be completed.

16. The method of claim 1, further comprising moving a start time or an end time of the purchased task to be performed by the service provider within the anchor in order to optimize a travel time associated with performing the purchased task.

17. The method of claim 1, wherein assigning the purchased task further comprises scheduling the purchased task to be performed in an available time slot that is in time proximity with a scheduled time slot associated with a scheduled task determined to be more proximate to the purchased task that other scheduled tasks of at least one service providers.

18. The method of claim 1, further comprising using the proximity of the home base locations of the service providers relative to the purchased task as a basis for selecting the service provider.

19. The method of claim 1, wherein receiving a defined time range, further comprises providing a price incentive to encourage a less restrictive defined time range and to be provided by a customer.

20. The method of claim 1, further comprising continuously rescheduling tasks for efficiency in compliance with anchors along with new observations, input from customers, input from service providers, and input from external data sources.

21. A method for scheduling a purchased task, the method comprising:
under the control of one or more computer systems configured with executable instructions:
receiving a defined time range and task-related parameters for when the purchased task is to be performed;
setting an anchor on a scheduling calendar according to the defined time range and task-related parameters received;
estimating a task duration to perform the purchased task;
identifying one or more service providers who are qualified and geographically eligible to perform the purchased task according to the anchor, a task location and for the task duration;
ranking scheduled tasks of the service providers based on a nearest ranked proximity to the purchased task;
selecting one of the service providers based on schedule efficiency as a function of the anchor of the purchased task in nearest ranked proximity to the scheduled anchors of the scheduled tasks for each service provider; and
assigning the purchased task to a selected service provider at an efficient scheduled time.

22. The method as in claim 21, further comprising scheduling the purchased task to be performed by the service provider with the scheduled task that is in nearest geographical proximity to the purchased task on the scheduling calendar, wherein the purchased task is scheduled within the anchor of the purchased task.

23. The method of claim 21, wherein estimating the task duration includes a travel time associated with performing the purchased task.

24. The method of claim 21, wherein estimating the task duration to perform the purchased task further comprises:
identifying previously performed tasks relating to the purchased task to be performed;
identifying previous task durations for the previously performed tasks; and
estimating the task duration for completing the purchased task for the customer based on the previous task durations of the previously completed tasks carried out by one or more service providers.

25. The method of claim 21, further comprising:
calculating a statistical variance of the previous task durations for the previously performed tasks relating to the purchased task; and
estimating the time duration to perform the purchased task based on the statistical variance of the previous task durations for the previously performed tasks.

26. The method of claim 21, wherein identifying one or more service providers further comprises:
analyzing scheduling calendars for a plurality of service providers, the scheduling calendars indicating time slots occupied by scheduled tasks; and
selecting a service provider with a scheduled task in an occupied time slot that falls within the anchor for the purchased task;
moving the scheduled task to another calendar time to improve schedule efficiency; and
scheduling the purchased task in the previously occupied time slot.

27. The method of claim 21, wherein identifying a service provider further comprises identifying the service provider based on a skill level possessed by the service provider to competently perform the purchased task.

28. The method of claim 21, further comprising optimizing the scheduling calendar of the service provider by applying a genetic algorithm to the scheduling calendar, the genetic algorithm including a genetic representation and a fitness function.

29. A system for scheduling a purchased task under the control of one or more computer systems configured with executable instructions, wherein the system includes:
a receiving module configured to receive a desired time range and parameters for the purchased task to be performed;
a time module configured to estimate a task duration to perform the purchased task;
an anchor module configured to set an anchor on a scheduling calendar according to the desired time range and parameters;
a service provider module configured to identify a service provider able to perform the purchased task according to the anchor and for the task duration;
a scheduling module configured to schedule the purchased task to be performed by the identified service provider based on schedule efficiency as a function of scheduled anchors of scheduled tasks for each service provider with respect to the anchor of the purchased task; and
an assignment module configured to assign the purchased task to the service provider.

30. The system of claim 29, wherein the service provider module is further configured to identify the service provider based on:
geographic proximity;
a service provider's schedule availability;
a service provider's defined territory; and
a skill level possessed by the service provider to competently perform the purchased task.

31. The system of claim 29, wherein the scheduling module is further configured to rearrange the purchased task desired by the customer and the scheduled task within the anchor to optimize travel times associated with performing the scheduled task and performing the purchased task for the customer.

32. The system of claim 29, selecting a service provider with a scheduled task most proximate to the anchor associated with the purchased task.

33. The system of claim 29, wherein the service provider module is biased toward maintaining a service provider assignment to a customer for whom the service provider has already performed a similar task.

34. A method of substantially maximizing efficiency of a service provider's schedule of tasks upon rescheduling a task in the schedule comprising:
under control of a processor and memory configured with executable instructions,
receiving a resolution for the task to be rescheduled;
setting an alternate anchor for the task to be rescheduled;
identifying anchors for other tasks in the schedule;
calculating schedule efficiency as a function of the alternate anchor for the task to be rescheduled and the existing anchors of the other tasks in the schedule; and
rescheduling the task in the schedule.

35. The method of claim 34, wherein the resolution is equal to a subset of the service provider's schedule of tasks in which the task to be rescheduled may be placed.

36. The method of claim 35, wherein the subset of the service provider's schedule of tasks is equal to a day, a half day, a week, a half week, several days, a number of hours on a specific day, a month, several months, or another desired temporal division of the service provider's schedule.

37. The method of claim 35, wherein schedule efficiency is calculated for all available times within the subset of the service provider's schedule.

38. The method of claim 37, wherein available times include times within an anchor of other tasks in the schedule.

39. The method of claim 37, wherein available times do not include times within an anchor of other tasks in the schedule.

40. The method of claim 37, wherein available times include only times within an existing anchor for the task being rescheduled.

41. The method of claim 38, wherein other tasks are allowed to move within the constraints of their respective anchors in determining substantially maximum efficiency.

42. The method of claim 34, wherein the resolution for the task to be rescheduled is received from the service provider, a customer, or an automated routine on a system hosting the schedule of tasks.

43. The method of claim 42, wherein the resolution for the task to be rescheduled is received from the service provider.

44. The method of claim 42, wherein selection of a resolution for the task to be rescheduled occurs using a graphical interface.

45. The method of claim 34, wherein schedule efficiency is calculated using a random-path genetic fitness function or other statistical methodology to estimate the substantively most efficient schedule.

46. The method of claim 45, wherein a change in efficiency upon rescheduling of a task is determined by calculating a change in travel requirements between the tasks on the schedule.

47. The method of claim 46, wherein the travel requirement is travel time.

48. The method of claim 47, wherein a travel time change calculation includes a factor selected from the group consisting essentially of: distance, traffic data, road data, weather condition data, or combinations thereof.

49. The method of claim 46, wherein the travel requirement is travel distance.

50. The method of claim 49, wherein the travel distance change calculation includes either distance according to established roads, or direct distance without regard to roads, or a combination thereof.

51. The method of claim 46, wherein the travel requirement is a travel-related monetary cost.

52. The method of claim 34, wherein a time selected for the rescheduling is selected using a processor to identify the time within a service provider's schedule that results in the greatest efficiency as compared to other times within the service provider's schedule.

53. The method of claim 34, further comprising providing an amount of efficiency as a quantified value to a graphical interface.

54. The method of claim 53, wherein a plurality of efficiency values are provided on the graphical interface according to the resolution received.

55. The method of claim 54, wherein the time selected for the rescheduling is selected by the service provider using the graphical interface.

56. A system for substantially maximizing efficiency of a service provider's schedule of tasks upon rescheduling an existing task in the schedule, the system comprising:
a receiving module to receive a resolution for an existing task to be rescheduled;
an anchor module configured to identify anchors for existing tasks in the schedule and either set an alternate anchor for the task that is to be rescheduled or reschedule the task within the task's existing anchor;
an efficiency calculating module configured to determine an efficiency of the schedule if the task to be rescheduled was relocated to a different time on the schedule;
a schedule management module configured to manage times of the tasks in the schedule using anchors for the existing tasks and an alternate anchor for the task to be rescheduled; and
a rescheduling module configured to reschedule the task to be rescheduled.

57. The system of claim 56, wherein the schedule management module is configured to identify available times in the schedule for the task to be rescheduled.

58. The system of claim 57, wherein the available times include times within anchors of other existing tasks on the schedule.

59. The system as is claim 56, further comprising a distance calculating module to determine travel requirements between locations of a service provider's schedule of tasks.

60. A method of substantially maximizing efficiency of a service provider's schedule of tasks upon rescheduling a task in the schedule comprising:
under control of a processor and memory configured with executable instructions,
receiving a resolution for the task to be rescheduled;
identifying anchors for other tasks in the schedule;
calculating schedule efficiency as a function of the alternate anchor for the task to be rescheduled and the existing anchors of the other tasks in the schedule; and
rescheduling the task in the schedule.

61. The method as in claim 60, further comprising setting an alternate anchor for the task to be rescheduled.
